(19) United States
(12) Patent Application Publication
(10) Pub. No.: US 2026/0134260 A1
(43) Pub. Date: May 14, 2026

(54) GENERATING SIMULATION-READY VIRTUAL CHARACTERS FROM NATURAL LANGAUGE INPUTS

(71) Applicant: NVIDIA CORPORATION, Santa Clara, CA (US)

(72) Inventors: Xueting LI, San Jose, CA (US); Umar IQBAL, Danville, CA (US); Ye YUAN, State College, PA (US); Jan KAUTZ, Lexington, MA (US); Shalini DE MELLO, San Francisco, CA (US); Miles MACKLIN, Auckland (NZ); Jonathan Christian LEAF, Austin, TX (US); Gilles DAVIET, Annecy (FR)

(21) Appl. No.: 19/335,680

(22) Filed: Sep. 22, 2025

Related U.S. Application Data
(60) Provisional application No. 63/720,102, filed on Nov. 13, 2024.

(51) Int. Cl. G06N 3/0455; G06T 15/00; G06T 17/30

(52) U.S. Cl. CPC G06N 3/0455; G06T 15/005; G06T 17/30

(57) ABSTRACT

The disclosed method for training machine learning models for object generation includes performing, based on object data, one or more operations to train an untrained machine learning model to generate a trained machine learning model that comprises a trained encoder and a trained decoder, wherein the trained machine learning model is trained to generate an object surface representation, performing, based on the object data and natural language data, one or more operations to train an untrained diffusion model to generate a trained diffusion model, where the trained diffusion model is trained to generate an object geometry embedding, and where the trained diffusion model and the trained decoder are used to generate a virtual object based on natural language input.

### CROSS-REFERENCE TO RELATED APPLICATIONS

This application claims priority benefit of the United States Provisional Patent Application titled, “TECHNIQUES FOR GENERATING SIMULATION-READY AVATARS WITH LAYERED HAIR AND CLOTHING FROM TEXTUARL DESCRIPTIONS,” filed on Nov. 13, 2024, and having Ser. No. 63/720,102. The subject matter of this related application is hereby incorporated herein by reference.

### BACKGROUND

### Technical Field

Embodiments of the present disclosure relate generally to computer science, artificial intelligence, and machine learning, and more specifically, to techniques for generating simulation-ready virtual characters from natural language inputs.

### Description of the Related Art

Virtual character generation refers to the use of computational algorithms for creating digital representations of characters for use in interactive or rendered environments, such as games, simulations, animated media, virtual reality, and/or the like. Virtual characters can include, but are not limited to, virtual humans, animals, fantastical creatures, humanoid robots, or other stylized or realistic entities. Virtual character generation systems are oftentimes integrated into real-time applications, such as video games, augmented reality (AR)/virtual reality (VR) experiences, and/or the like, or used in offline pipelines for film production, digital twin simulation, synthetic data generation, and/or the like.

Conventional approaches for virtual character generation oftentimes use template-based pipelines and manually defined asset hierarchies to construct virtual characters from a set of predefined components. In such approaches, the character generation process is typically divided into distinct modules for modeling base geometry, attaching surface features, such as garments or hair, and assigning textures or materials. The base geometry module defines the underlying skeletal or mesh structure, often derived from parametric body models or scanned exemplars. The garment and hair modules then attach geometry that conforms to the base mesh using predefined binding rules or mesh deformation techniques. Texture mapping and material assignment modules apply visual properties to each surface, either procedurally or using artist-defined templates. For example, conventional approaches for virtual character generation can use standard skinning and rigging techniques to animate characters and procedural tools to generate clothing layers based on user-selected parameters.

One drawback of the above approaches for virtual character generation is the reliance on manually defined asset hierarchies and predefined geometry templates, which limits the ability to generalize across diverse character types, poses, and appearances. In flexible content creation settings, a virtual world requires virtual characters that vary significantly in body shape, clothing style, or surface complexity, or that respond dynamically to user input or physical simulation. For example, a video game could feature a large variety of non-human characters, each with distinct anatomy and outer coverings, while a virtual production pipeline could require a single character to appear in different outfits or hairstyles across scenes. Virtual character generation systems that depend on fixed mesh topologies or template-driven pipelines often require extensive manual adjustment or reauthoring to support such diversity and are less suitable for large-scale generation or dynamic simulation.

Another drawback of the above approaches is that rigid binding and deformation schemes can complicate the integration of advanced rendering or physics models, especially when garments or hair has to move independently in response to environmental or character-specific movements. For example, in scenarios where a character is animated performing dynamic actions, such as jumping or spinning, rigidly bound garments may unnaturally stretch or remain static, failing to exhibit realistic secondary motion. In more extreme cases, rigid binding and deformation schemes can even generate artifacts, such as garment ripping, floating cloth regions, or stiff, unresponsive hair strands, all of which diminish the visual realism and physical plausibility of the character appearance.

As the foregoing illustrates, what is needed in the art are more effective techniques for virtual character generation.

### SUMMARY

According to some embodiments, a computer-implemented method for training machine learning models for object generation includes performing, based on object data, one or more operations to train an untrained machine learning model to generate a trained machine learning model that comprises a trained encoder and a trained decoder, wherein the trained machine learning model is trained to generate an object surface representation. The method further includes performing, based on the object data and natural language data, one or more operations to train an untrained diffusion model to generate a trained diffusion model, wherein the trained diffusion model is trained to generate an object geometry embedding. The trained diffusion model and the trained decoder are used to generate a virtual object based on natural language input.

According to some embodiments, a computer-implemented method for generating a virtual object includes processing a language embedding associated with a natural language description of an object using a trained diffusion model to generate a first object geometry embedding. The method also includes processing the first object geometry embedding using a trained decoder to generate an object surface representation. The method further includes converting the object surface representation into a first object geometry of the virtual object.

Further embodiments provide, among other things, non-transitory computer-readable storage media storing instructions and systems configured to implement the method set forth above.

At least one technical advantage of the disclosed techniques relative to the prior art is that the disclosed techniques eliminate the need for manually defined asset hierarchies and fixed mesh templates by introducing machine learning models, such as variational autoencoders and diffusion models, that directly learn garment, hair, and body geometry representations from data. The models are trained to generate high-fidelity surface representations conditioned on natural language prompts, enabling generalization across a wide range of character shapes, clothing styles, and appearance variations without the need for manual reauthoring or retargeting. Additionally, the disclosed techniques generate continuous surface representations, such as unsigned distance fields (UDFs), that avoid the constraints of rigid skinning and deformation, allowing garments and hair to exhibit more realistic motion and interaction with physical environments or character movements. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, can be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computer system configured to implement one or more aspects of various embodiments;

FIG. 2A is a more detailed illustration of the machine learning server of FIG. 1, according to various embodiments;

FIG. 2B is a more detailed illustration of the computing device of FIG. 1, according to various embodiments;

FIG. 3A illustrates how the model trainer of FIG. 1 trains a garment variational autoencoder, according to various embodiments;

FIG. 3B is a more detailed illustration of the garment variational autoencoder, according to various embodiments;

FIG. 4 illustrates how the model trainer of FIG. 1 trains a garment diffusion model, according to various embodiments;

FIG. 5 is a more detailed illustration of the character generation application of FIG. 1, according to various embodiments;

FIG. 6 is a flow diagram of method steps for training the garment variational autoencoder and the garment diffusion model, according to various embodiments;

FIG. 7 is a flow diagram of method steps for training the encoder and the decoder, according to various embodiments;

FIG. 8 is a flow diagram of method steps for a generating garment geometry embedding, according to various embodiments;

FIG. 9 is a flow diagram of method steps for generating a reconstructed garment surface representation, according to various embodiments;

FIG. 10 is a flow diagram of method steps for training a garment diffusion model, according to various embodiments; and

FIG. 11 is the flow diagram of method steps for generating a virtual character, according to various embodiments.

### DETAILED DESCRIPTION

In the following description, numerous specific details are set forth to provide a more thorough understanding of the various embodiments. However, it will be apparent to one skilled in the art that the concepts can be practiced without one or more of these specific details.

### General Overview

Embodiments of the present disclosure provide techniques for virtual character generation. In some embodiments, a model trainer trains a garment variational autoencoder and a garment diffusion model based on training data. The garment variational autoencoder is a machine learning model, which processes a garment geometry, such as a point cloud, and generates a reconstructed garment surface representation, such as an unsigned distance field (UDF) or occupancy field. In some embodiments, the garment variational autoencoder includes, without limitation, an encoder and a decoder. In some embodiments, the model trainer trains the garment variational autoencoder based on garment data included in the training data. During the training of the garment variational autoencoder, a garment data processing module processes the garment data and generates the garment geometry and a garment surface representation. The encoder, which is a machine learning model, processes the garment geometry and generates a garment geometry embedding. The decoder, which is another machine learning model, processes the garment geometry embedding and generates the reconstructed garment surface representation. A loss calculator calculates a first loss based on the reconstructed garment geometry, the garment surface representation, and the garment geometry. The model trainer uses the first loss to update the parameters of the garment variational autoencoder until one or more stopping criteria are met. Once the garment variational autoencoder is trained, the model trainer uses the trained encoder to train the garment diffusion model based on the training data. During the training of the garment diffusion model, the garment data processing module processes the garment data and generates the garment geometry. The trained encoder processes the garment geometry and generates garment geometry embeddings. A noise adder adds noise to a garment geometry embedding to generate a noisy garment geometry embedding. A language model processes natural language data included in the training data and generates a language embedding. The garment diffusion model performs one or more denoising diffusion steps to process the noisy garment geometry embedding and the language embedding to generate a predicted garment geometry embedding. The loss calculator calculates a second loss based on the predicted garment geometry embedding and the garment geometry embedding. The model trainer uses the second loss to iteratively update the parameters of the garment diffusion model until one or more stopping criteria are met.

In some embodiments, once the training is complete, a character generation application can use a garment geometry generator along with a body geometry generator and hair geometry generator to process a natural language input and generate a virtual character. In some embodiments, the character generation application includes, without limitation, the garment geometry generator and a character appearance optimizer. The garment geometry generator is a module that uses the trained garment diffusion model and the trained decoder to process a language embedding and generate a garment geometry. During inference, the language model processes a natural language input received from one or more I/O devices and generates the language embedding. The hair geometry generator is a module that processes the language embedding and generates hair geometry. The body geometry generator is a module that processes the language embedding and generates a body geometry. The trained garment diffusion model processes the language embedding and generates the predicted garment geometry embedding. The trained decoder processes the garment geometry embedding and generates the reconstructed garment surface representation. The garment geometry generator processes the reconstructed garment surface representation and generates the garment geometry. The character appearance optimizer is a module that uses one or more Gaussians to optimize a character appearance based on the hair geometry, the body geometry, the garment geometry, and the natural language input generating optimized character appearance. The character generation application generates a virtual character that includes the optimized character appearance, the body geometry, the hair geometry, and the garment geometry. At least one technical advantage of the disclosed techniques relative to the prior art is that the disclosed techniques eliminate the need for manually defined asset hierarchies and fixed mesh templates by introducing machine learning models, such as variational autoencoders and diffusion models, that directly learn garment, hair, and body geometry representations from data. The models are trained to generate high-fidelity surface representations conditioned on natural language prompts, enabling generalization across a wide range of character shapes, clothing styles, and appearance variations without the need for manual reauthoring or retargeting. Additionally, the disclosed techniques generate continuous surface representations, such as UDFs, that avoid the constraints of rigid skinning and deformation, allowing garments and hair to exhibit more realistic motion and interaction with physical environments or character movements. These technical advantages provide one or more technological improvements over prior art approaches.

The virtual character generation techniques of the present disclosure have many real-world applications. For example, the virtual character generation techniques could be used to create digital characters in interactive applications, such as video games, simulations, or virtual production environments. As another example, the techniques could be applied to generate characters with movable joints, such as humanoid avatars, animal characters, or robotic figures, for use in animated media, training simulators, or immersive virtual experiences.

The above examples are not in any way intended to be limiting. As persons skilled in the art will appreciate, as a general matter, the robot control techniques described herein can be implemented in any suitable application.

### System Overview

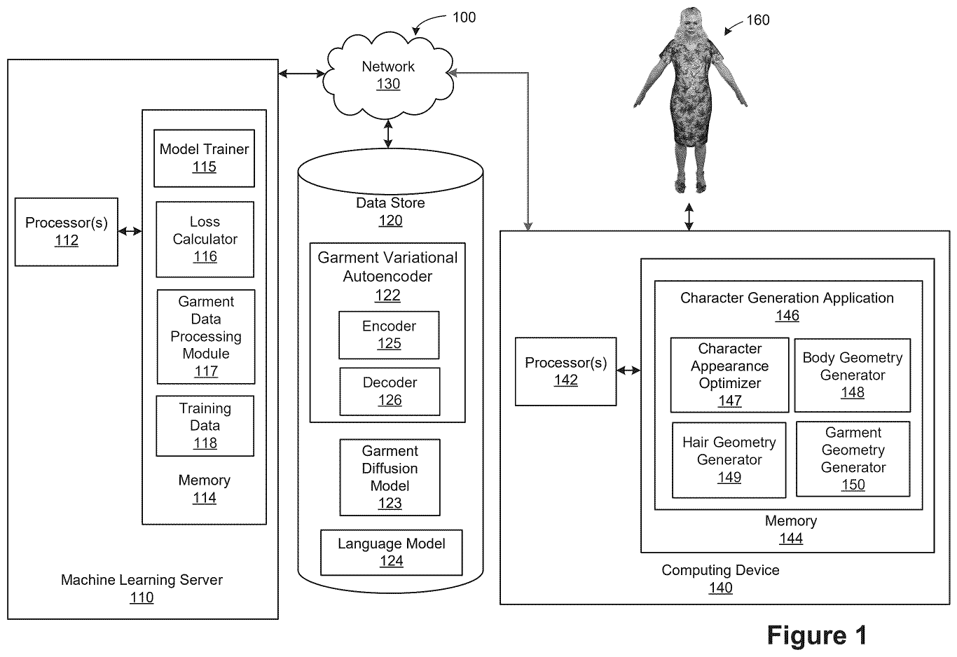

FIG. 1 illustrates a block diagram of a computer-based system 100 configured to implement one or more aspects of at least one embodiment. As shown, system 100 includes a machine learning server 110, a data store 120, and a computing device 140 in communication over a network 130, which can be a wide area network (WAN) such as the Internet, a local area network (LAN), a cellular network, and/or any other suitable network. Machine learning server 110 includes, without limitation, processor(s) 112 and a memory 114. Memory 114 includes, without limitation, a model trainer 115, a loss calculator 116, a garment data processing module 117, and training data 118. Data store 120 includes, without limitation, a garment variational autoencoder 122, a garment diffusion model 123, and a language model 124. Garment variational autoencoder 122 includes, without limitation, an encoder 125 and a decoder 126. Computing device 140 includes, without limitation, processor(s) 142 and a memory 144. Memory 144 includes, without limitation, a character generation application 146. Character generation application 146 includes, without limitation, a character appearance optimizer 147, a body geometry generator 148, a hair geometry generator 149, and a garment geometry generator 150.

Processor(s) 112 receive user input from input devices, such as a keyboard or a mouse. Processor(s) 112 may include one or more primary processors of machine learning server 110, controlling and coordinating operations of other system components. In particular, processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

System memory 114 of machine learning server 110 stores content, such as software applications and data, for use by processor(s) 112 and the GPU(s) and/or other processing units. System memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

Machine learning server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in system memory 114 can be modified as desired. Further, the connection topology between the various units in FIG. 1 can be modified as desired. In some embodiments, any combination of processor(s) 112, system memory 114, and/or GPU(s) can be included in and/or replaced with any type of virtual computing system, distributed computing system, and/or cloud computing environment, such as a public, private, or a hybrid cloud system.

As shown, garment data processing module 117 executes on one or more processors 112 of machine learning server 110 and is stored in system memory 114 of machine learning server 110. In some embodiments, garment data processing module 117 is an application or module thereof that processes garment data included in training data 118 and generates garment geometry, such as a point cloud and/or the like, and optionally a garment surface representation, such as an unsigned distance field (UDF), occupancy field, and/or the like. Training data 118, which can be stored in memory 114 or elsewhere (e.g., data store 120), includes the garment data and natural language data. In some embodiments, the garment data includes 3D garment meshes, surface point clouds, and/or volumetric fields representing garment geometry. In some embodiments, the language data includes, without limitation, text prompts, labels, and/or descriptions associated with each garment (e.g., “a short-sleeved t-shirt” or “a long floral dress”). In some examples, training data 119 includes garment meshes from the Garment Pattern Generator (GPG) dataset and the CLOTH3D dataset. For garments in the GPG dataset, predefined prompt annotations can be used as text descriptions included in the natural language data. For the CLOTH3D dataset, which lacks textual prompts, each garment can be rendered on a Skinned Multi-Person Linear (SMPL) body mesh, and a large language model (e.g., GPT-4V), such as language model 124, can be queried using predefined questions to generate text descriptions describing the type, shape, length, and width of each garment. As a result, training data 118 includes a fixed number (e.g., approximately 20,000) garments with paired text prompts covering various garment types, such as t-shirts, tank tops, jackets, shorts, pants, skirts, and dresses.

As shown, model trainer 115 is an application that executes on one or more processors 112 of machine learning server 110 and is stored in a system memory 114 of machine learning server 110. Although shown as distinct from the loss calculator 116 and garment data processing module 117 for illustrative purposes, in some embodiments, functionality of model trainer 115, loss calculator 116, and garment data processing module 117 can be combined into a single application.

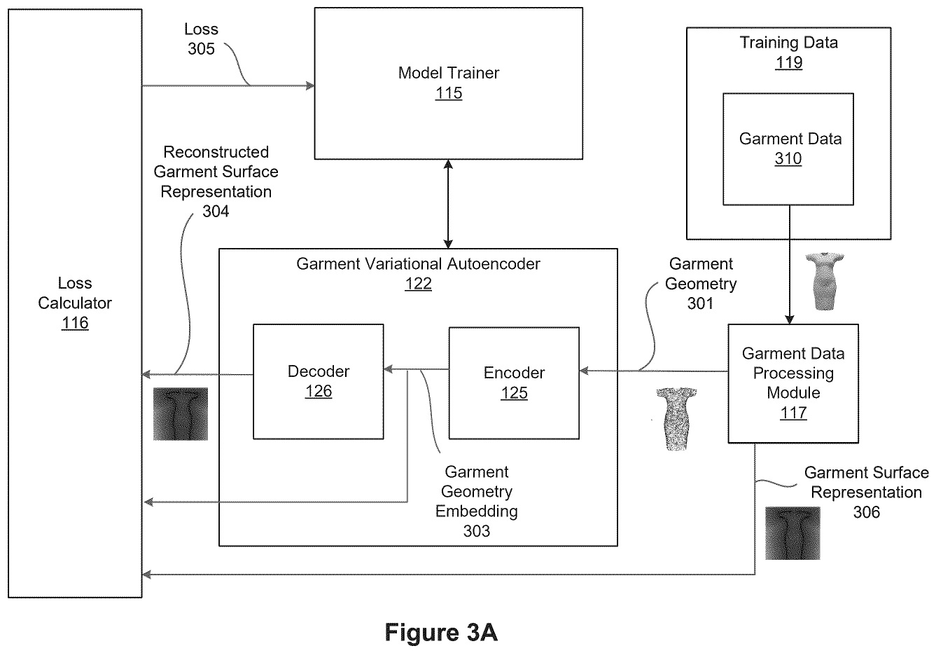

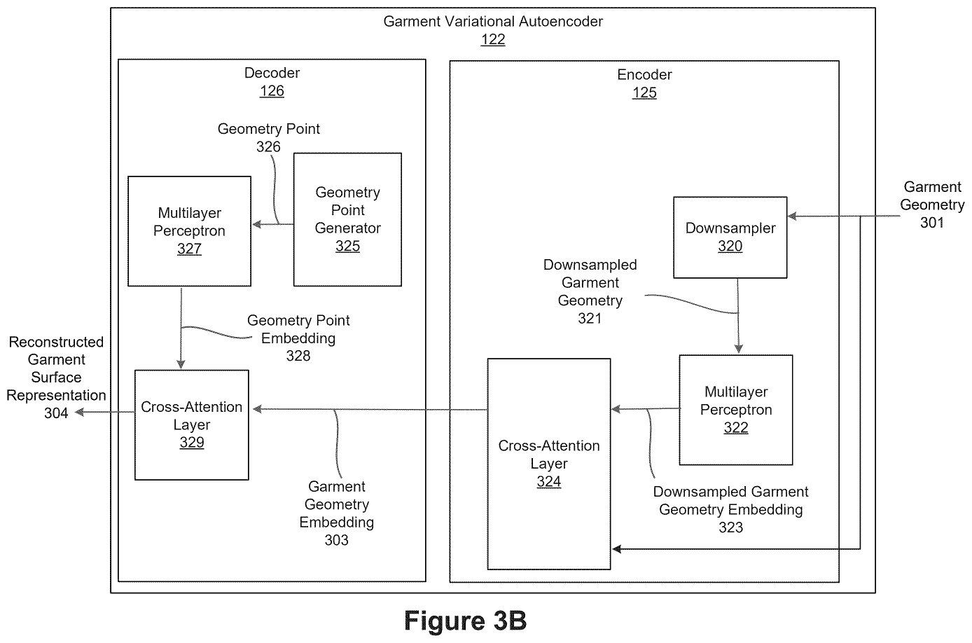

In some embodiments, model trainer 115 is configured to train one or more machine learning models, including garment variational autoencoder 122 and garment diffusion model 123. Garment variational autoencoder 122 is a machine learning model, such as a neural network, which is trained to generate a reconstructed surface representation. Garment variational autoencoder 122 is described in greater detail in conjunction with FIGS. 3B and 8-9. Garment diffusion model 123 is a machine learning model, such as a diffusion model, which is trained to generate a predicted geometry garment geometry embedding. Techniques for training garment variational autoencoder 122 and garment diffusion model 123 based on training data 118 are discussed in greater detail herein in conjunction with at least FIGS. 3A-4 and 6-10. Garment variational autoencoder 122 and garment diffusion model 123 can be stored in data store 120. Although shown as being stored in data store 120 in FIG. 1, garment variational autoencoder 122 and garment diffusion model 123 can be stored in memory 114 during training or can be stored in memory 144 during inference. In some embodiments, the same computing device(s) can be used for training and inference after training, rather than the separate machine learning server 110 and computing device 140. In some embodiments, data store 120 can include any storage device or devices, such as fixed disc drive(s), flash drive(s), optical storage, network attached storage (NAS), and/or a storage area-network (SAN). Although shown as accessible over network 130, in at least one embodiment machine learning server 110 can include data store 120.

As shown, loss calculator 116 executes on one or more processors 112 of machine learning server 110 and is stored in system memory 114 of machine learning server 110. In some embodiments, loss calculator 116 is an application or module thereof that calculates a first loss for training garment variational autoencoder 122 based on the reconstructed garment surface representation and the garment surface representation, described above. In some embodiments, loss calculator 116 calculates a second loss for training garment diffusion model 123 based on a garment geometry embedding and the predicted garment geometry embedding, described above.

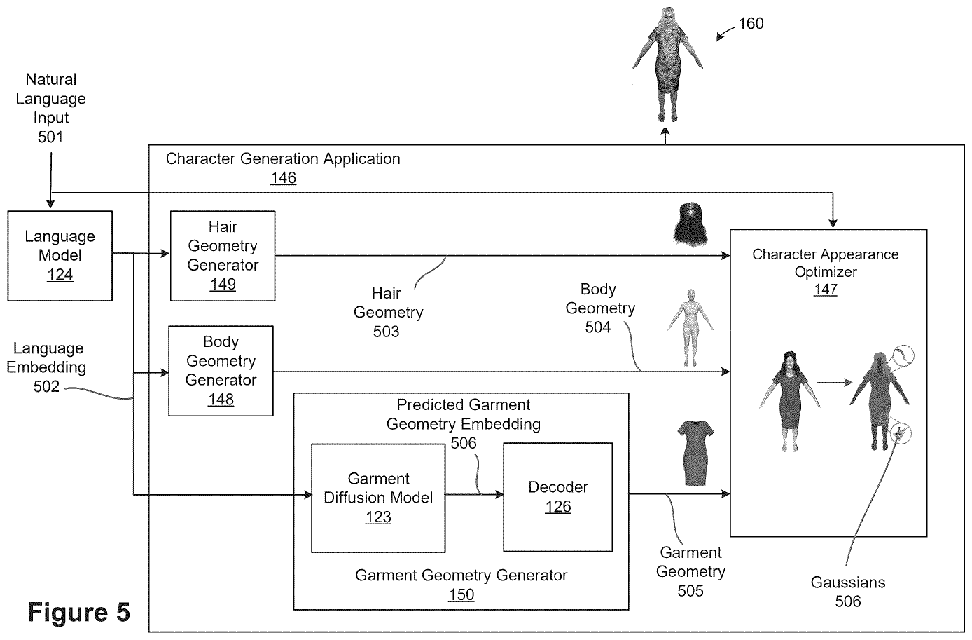

As shown, a character generation application 146 that uses decoder 126 and garment diffusion model 123 is stored in memory 144, and executes on processor(s) 142, of computer device 140. Once trained, trained decoder 126 and garment diffusion model 123 can be deployed, such as via garment geometry generator 150 included in character generation application 146, to process a language embedding and generate a garment geometry. Language model 124, which is stored in data store 120 and accessed over network 130, processes a natural language input received from one or more I/O devices (not shown) and generates the language embedding. Memory 144 and the processor(s) 142 can be similar to memory 114 and processor(s) 112 of machine learning server 110, described above. Body geometry generator 148 is a module of character generation application 146 that processes the language embedding and generates a body geometry. Hair geometry generator 149 is a module of character generation application 146 that processes the language embedding and generates a hair geometry. Character appearance optimizer 147 is a module of character generation application 146 that uses one or more Gaussians to generate an optimized character appearance based on the body geometry, the hair geometry, the garment geometry, and the natural language input. Character generation application 146 can be used to generate a virtual character, such as virtual character 160, based on the optimized character appearance. Although an example of virtual character 160 is shown for illustrative purposes, in at least one embodiment, techniques disclosed herein can be applied to generate any virtual character, such as an animal or an object. Character generation application 146 is discussed in greater detail below in conjunction with FIGS. 5-11.

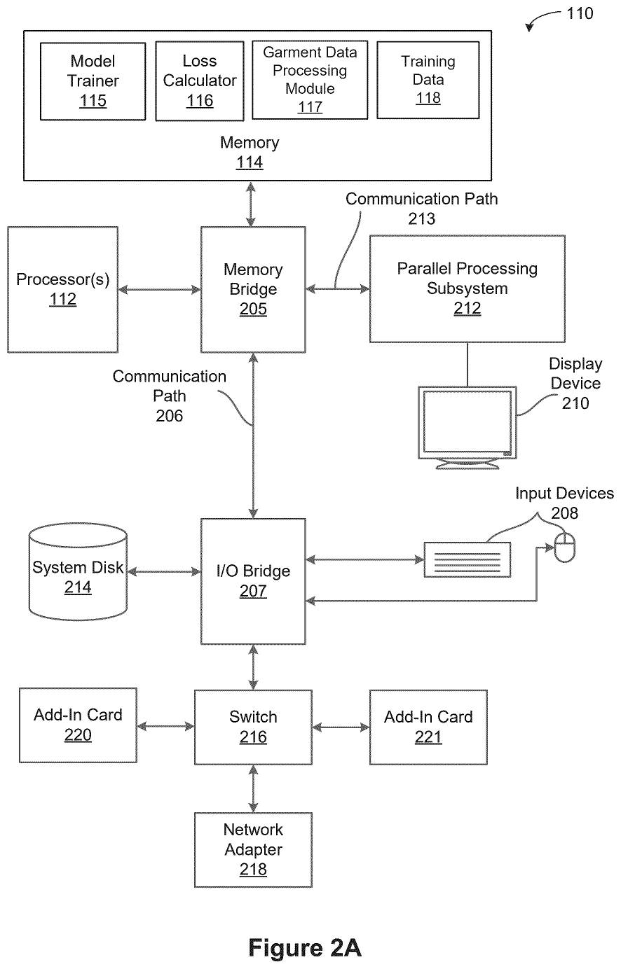

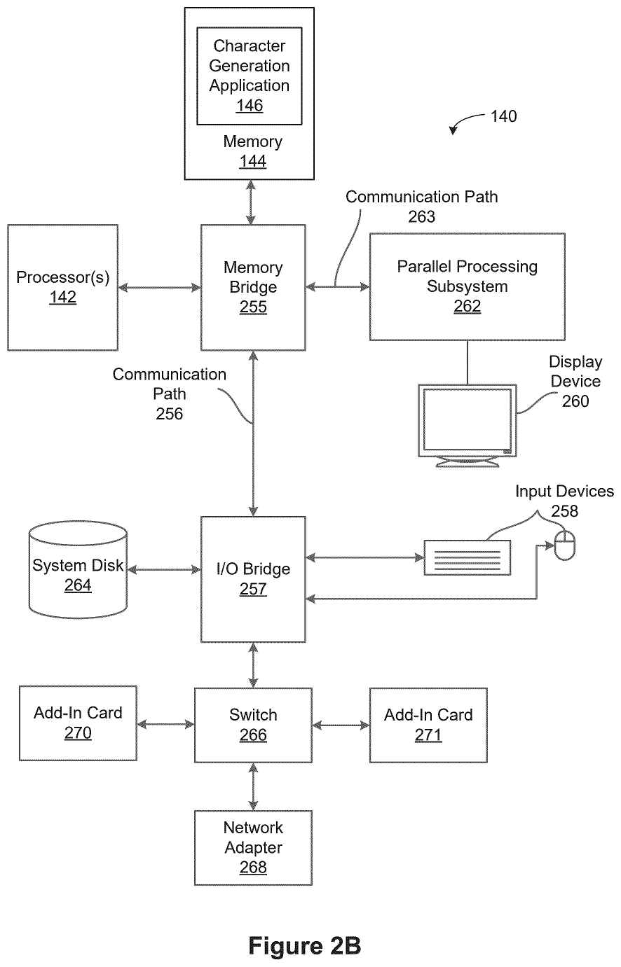

FIG. 2A is a block diagram illustrating machine learning server 110 of FIG. 1 in greater detail, according to various embodiments. Machine learning server 110 may include any type of computing system, including, without limitation, a server machine, a server platform, a desktop machine, a laptop machine, a hand-held/mobile device, a digital kiosk, an in-vehicle infotainment system, and/or a wearable device. In some embodiments, machine learning server 110 is a server machine operating in a data center or a cloud computing environment that provides scalable computing resources as a service over a network.

In various embodiments, machine learning server 110 includes, without limitation, processor(s) 112 and memory(ies) 114 coupled to a parallel processing subsystem 212 via a memory bridge 205 and a communication path 213. Memory bridge 205 is further coupled to an I/O (input/output) bridge 207 via a communication path 206, and I/O bridge 207 is, in turn, coupled to a switch 216.

In one embodiment, I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to processor(s) 112 for processing. In some embodiments, machine learning server 110 may be a server machine in a cloud computing environment. In such embodiments, machine learning server 110 may not include input devices 208, but may receive equivalent input information by receiving commands (e.g., responsive to one or more inputs from a remote computing device) in the form of messages transmitted over a network and received via network adapter 218. In some embodiments, switch 216 is configured to provide connections between I/O bridge 207 and other components of machine learning server 110, such as a network adapter 218 and various add-in cards 220 and 221.

In some embodiments, I/O bridge 207 is coupled to a system disk 214 that may be configured to store content and applications and data for use by processor(s) 142 and parallel processing subsystem 212. In one embodiment, system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 207 as well.

In various embodiments, memory bridge 205 may be a Northbridge chip, and I/O bridge 207 may be a Southbridge chip. In addition, communication paths 206 and 213, as well as other communication paths within machine learning server 110, may be implemented using any technically suitable protocols, including, without limitation, AGP (Accelerated Graphics Port), HyperTransport, or any other bus or point-to-point communication protocol known in the art.

In some embodiments, parallel processing subsystem 212 comprises a graphics subsystem that delivers pixels to an optional display device 210 that may be any conventional cathode ray tube, liquid crystal display, light-emitting diode display, and/or the like. In such embodiments, parallel processing subsystem 212 may incorporate circuitry optimized for graphics and video processing, including, for example, video output circuitry. Such circuitry may be incorporated across one or more parallel processing units (PPUs), also referred to herein as parallel processors, included within parallel processing subsystem 212.

In some embodiments, parallel processing subsystem 212 incorporates circuitry optimized (e.g., that undergoes optimization) for general purpose and/or compute processing. Again, such circuitry may be incorporated across one or more PPUs included within parallel processing subsystem 212 that are configured to perform such general purpose and/or compute operations. In yet other embodiments, the one or more PPUs included within parallel processing subsystem 212 may be configured to perform graphics processing, general purpose processing, and/or compute processing operations. System memory 114 includes at least one device driver configured to manage the processing operations of the one or more PPUs within parallel processing subsystem 212. In addition, system memory 114 includes, without limitation, model trainer 115, loss calculator 116, garment data processing module 117, and training data 118. Although described herein primarily with respect to model trainer 115, loss calculator 116, garment data processing module 117, and training data 118, techniques disclosed herein can also be implemented, either entirely or in part, in other software and/or hardware, such as in parallel processing subsystem 212.

In various embodiments, parallel processing subsystem 212 may be integrated with one or more of the other elements of FIG. 2A to form a single system. For example, parallel processing subsystem 212 may be integrated with processor 142 and other connection circuitry on a single chip to form a system on a chip (SoC).

In some embodiments, processor(s) 112 includes the primary processor of machine learning server 110, controlling and coordinating operations of other system components. In some embodiments, processor(s) 112 issues commands that control the operation of PPUs. In some embodiments, communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 112, and the number of parallel processing subsystems 212, may be modified as desired. For example, in some embodiments, system memory 114 could be connected to the processor(s) 112 directly rather than through memory bridge 205, and other devices may communicate with system memory 114 via memory bridge 205 and processor 112. In other embodiments, parallel processing subsystem 212 may be connected to I/O bridge 207 or directly to processor 112, rather than to memory bridge 205. In still other embodiments, I/O bridge 207 and memory bridge 205 may be integrated into a single chip instead of existing as one or more discrete devices. In certain embodiments, one or more components shown in FIG. 2A may not be present. For example, switch 216 could be eliminated, and network adapter 218 and add-in cards 220, 221 would connect directly to I/O bridge 207. Lastly, in certain embodiments, one or more components shown in FIG. 2A may be implemented as virtualized resources in a virtual computing environment, such as a cloud computing environment. In particular, the parallel processing subsystem 212 may be implemented as a virtualized parallel processing subsystem in at least one embodiment. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

FIG. 2B is a block diagram illustrating computing device 140 of FIG. 1 in greater detail, according to various embodiments. Computing device 140 may include any type of computing system, including, without limitation, a server machine, a server platform, a desktop machine, a laptop machine, a hand-held/mobile device, a digital kiosk, an in-vehicle infotainment system, and/or a wearable device. In some embodiments, computing device 140 is a server machine operating in a data center or a cloud computing environment that provides scalable computing resources as a service over a network. In some embodiments, machine learning server 110 can include one or more similar components as computing device 140.

In various embodiments, computing device 140 includes, without limitation, processor(s) 142 and memory(ies) 144 coupled to a parallel processing subsystem 262 via a memory bridge 255 and a communication path 263. Memory bridge 255 is further coupled to an I/O (input/output) bridge 257 via a communication path 256, and I/O bridge 257 is, in turn, coupled to a switch 266.

In one embodiment, I/O bridge 257 is configured to receive user input information from optional input devices 258, such as a keyboard, mouse, touch screen, sensor data analysis (e.g., evaluating gestures, speech, or other information about one or more uses in a field of view or sensory field of one or more sensors), and/or the like, and forward the input information to processor(s) 142 for processing. In some embodiments, computing device 140 may be a server machine in a cloud computing environment. In such embodiments, computing device 140 may not include input devices 258, but may receive equivalent input information by receiving commands (e.g., responsive to one or more inputs from a remote computing device) in the form of messages transmitted over a network and received via network adapter 268. In some embodiments, switch 266 is configured to provide connections between I/O bridge 257 and other components of computing device 140, such as a network adapter 268 and various add-in cards 270 and 271.

In some embodiments, I/O bridge 257 is coupled to a system disk 264 that may be configured to store content and applications and data for use by processor(s) 142 and parallel processing subsystem 262. In one embodiment, system disk 264 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In various embodiments, other components, such as universal serial bus or other port connections, compact disc drives, digital versatile disc drives, film recording devices, and the like, may be connected to I/O bridge 257 as well.

In various embodiments, memory bridge 255 may be a Northbridge chip, and I/O bridge 257 may be a Southbridge chip. In addition, communication paths 256 and 263, as well as other communication paths within computing device 140, may be implemented using any technically suitable protocols, including, without limitation, AGP (Accelerated Graphics Port), HyperTransport, or any other bus or point-to-point communication protocol known in the art.

In some embodiments, parallel processing subsystem 262 comprises a graphics subsystem that delivers pixels to an optional display device 260 that may be any conventional cathode ray tube, liquid crystal display, light-emitting diode display, and/or the like. In such embodiments, parallel processing subsystem 262 may incorporate circuitry optimized for graphics and video processing, including, for example, video output circuitry. Such circuitry may be incorporated across one or more parallel processing units (PPUs), also referred to herein as parallel processors, included within parallel processing subsystem 262.

In some embodiments, parallel processing subsystem 262 incorporates circuitry optimized (e.g., that undergoes optimization) for general purpose and/or compute processing. Again, such circuitry may be incorporated across one or more PPUs included within parallel processing subsystem 262 that are configured to perform such general purpose and/or compute operations. In yet other embodiments, the one or more PPUs included within parallel processing subsystem 262 may be configured to perform graphics processing, general purpose processing, and/or compute processing operations. System memory 144 includes at least one device driver configured to manage the processing operations of the one or more PPUs within parallel processing subsystem 262. In addition, system memory 144 includes character generation application 146. Although described herein primarily with respect to character generation application 146, techniques disclosed herein can also be implemented, either entirely or in part, in other software and/or hardware, such as in parallel processing subsystem 262.

In various embodiments, parallel processing subsystem 262 may be integrated with one or more of the other elements of FIG. 2B to form a single system. For example, parallel processing subsystem 262 may be integrated with processor 142 and other connection circuitry on a single chip to form a system on a chip (SoC).

In some embodiments, processor(s) 142 includes the primary processor of computing device 140, controlling and coordinating operations of other system components. In some embodiments, processor(s) 142 issue commands that control the operation of PPUs. In some embodiments, communication path 263 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of CPUs 142, and the number of parallel processing subsystems 262, may be modified as desired. For example, in some embodiments, system memory 144 could be connected to processor(s) 142 directly rather than through memory bridge 255, and other devices may communicate with system memory 144 via memory bridge 255 and processor 142. In other embodiments, parallel processing subsystem 262 may be connected to I/O bridge 257 or directly to processor 142, rather than to memory bridge 255. In still other embodiments, I/O bridge 257 and memory bridge 255 may be integrated into a single chip instead of existing as one or more discrete devices. In certain embodiments, one or more components shown in FIG. 2B may not be present. For example, switch 266 could be eliminated, and network adapter 268 and add-in cards 270, 271 would connect directly to I/O bridge 257. Lastly, in certain embodiments, one or more components shown in FIG. 2B may be implemented as virtualized resources in a virtual computing environment, such as a cloud computing environment. In particular, parallel processing subsystem 262 may be implemented as a virtualized parallel processing subsystem in at least one embodiment. For example, parallel processing subsystem 262 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Training Garment Variational Autoencoder Based on Garment Data

FIG. 3A illustrates how model trainer 115 trains garment variational autoencoder 122, according to various embodiments. As shown, garment variational encoder 122 includes, without limitation, encoder 125 and decoder 126. Training data 119 includes, without limitation, garment data 310. In operation, garment data processing module 117 processes garment data 310 and generates garment geometry 301 and a garment surface representation 306. Although described herein with respect to garments as a reference example, in some embodiments, geometry and/or surface representations of any suitable objects (e.g., an entire virtual character) can be generated instead of garments. Encoder 125 processes garment geometry 301 and generates garment geometry embedding 303. Decoder 126 processes garment geometry embedding 303 and generates reconstructed garment surface representation 304. Loss calculator 116 calculates loss 305 based on reconstructed garment geometry 304, garment surface representation 306, and garment geometry embedding 303. Model trainer 115 uses loss 305 to update the parameters of garment variational autoencoder 122 until one or more stopping criteria are met.

Garment data processing module 117 is an application or module of an application that processes garment data 310 and generates garment geometry 301 and garment surface representation 306. In some embodiments, garment data 310 includes 3D garment meshes, such as triangle meshes, point clouds, volumetric distance fields, and/or the like. In some embodiments, garment data processing module 117 extracts surface points from the 3D garment mesh included in garment data 310 to generate garment geometry 301 as a point cloud or another suitable format. In some embodiments, garment data processing module 117 generates garment surface representation 306 by uniformly sampling a set of 3D query points within a bounding box that fully encloses the 3D garment mesh and, for each query point, computing the unsigned Euclidean distance (e.g., UDF) to the closest surface point on the 3D garment mesh. In UDF, each query point is associated with a scalar value indicating the distance of the point from the surface. In some embodiments, the UDF is thresholded to assign a binary label to each query point indicating whether the point lies within a specified distance of the garment surface.

Garment variational autoencoder 122 is a machine learning model, such as a neural network, that processes garment geometry 301 and generates reconstructed garment surface representation 304. As described, garment variational encoder 122 includes, without limitation, encoder 125 and decoder 126. Encoder 125 is a machine learning model, such as a neural network, that processes garment geometry 301 and generates garment geometry embedding 303. In some embodiments, encoder 125 includes, without limitation, a downsampler, a first multilayer perceptron, and a first cross attention layer. In operation, the downsampler processes garment geometry 301, such as a high-resolution 3D mesh or point cloud, and generates a downsampled garment geometry. The first multilayer perceptron processes the downsampled garment geometry and generates a downsampled garment geometry embedding, which encodes local shape features for each downsampled point. The first cross-attention layer processes the downsampled garment geometry embedding and garment geometry 301 and generates garment geometry embedding 303. Decoder 126 is a machine learning model, such as a neural network, that processes garment geometry embedding 303 and garment geometry 301 and generates reconstructed garment surface representation 304. In some embodiments, decoder 126 includes, without limitation, a geometry point generator, a second multilayer perceptron, and a second cross-attention layer. The geometry point generator generates a geometry point by sampling one or more 3D spatial locations over the garment space, which could correspond to query points used to reconstruct the surface or occupancy field. The second multi-layer perceptron processes the geometry point and generates a geometry point embedding, which encodes spatial context at each queried location. The second cross-attention layer processes garment geometry embedding 303 and garment point embedding and generates reconstructed garment representation 304, such as a UDF or occupancy field. Garment variational autoencoder 122 is described in greater detail in conjunction with FIGS. 3B, 8, and 9.

Loss calculator 116 is an application that calculates loss 305 based on garment surface representation 306, reconstructed garment surface representation 304, and garment geometry embedding 303. In some embodiments, garment surface representation 306 includes unsigned distance values associated with a set of 3D query points sampled around a garment. Reconstructed garment surface representation 304 includes predicted unsigned distances at the 3D query points. In some embodiments, loss calculator 116 calculates a binary cross-entropy loss based on the predicted UDF included in reconstructed garment surface representation 304 and ground truth UDF included in garment surface representation 306. In some embodiments, loss calculator 116 calculates an L2 loss between the spatial gradients of the predicted distance fields included in reconstructed garment surface representation 304 and ground truth distance fields included in garment surface representation 306 at the query points to permit geometric smoothness. In some embodiments, loss calculator 116 calculates a Kullback-Leibler (KL) divergence loss on the latent variables included in garment geometry embedding 303 to regularize the latent space during training. In some embodiments, loss calculator 116 calculates loss 305 based on the binary cross-entropy loss, the L2 gradient loss, and the KL divergence loss. For example, loss calculator 116 can calculate loss 305 according to the following formula:

$$L = {L}_{b c e} + {λ}_{grad} {L}_{grad} + {λ}_{K L} {L}_{K L} , \qquad ( Equation 1 )$$

where L_{bce} is the binary cross-entropy loss, L_{grad} is the gradient loss (e.g., L2 loss), and L_{KL} is the KL divergence loss. In some examples, the weighting coefficients λ_{grad} and λ_{KL} are empirically selected, such as 0.0001 and 0.1, respectively.

Model trainer 115 uses loss 305 to iteratively update the parameters of garment variational autoencoder 122. In some embodiments, model trainer 115 uses loss 305 to perform backpropagation and update the trainable parameters of garment variational autoencoder 122 using an optimization algorithm, such as stochastic gradient descent (SGD), adaptive moment estimation (Adam), and/or the like. In some embodiments, model trainer 115 updates the parameters of garment variational autoencoder 122 iteratively until one or more stopping criteria are met, such as a fixed number of epochs, convergence of loss 305, and/or the like. Once model trainer 115 trains garment variational autoencoder 122, model trainer 115 stores the trained garment variational autoencoder 122 in datastore 120 or elsewhere.

### Garment Variational Autoencoder

FIG. 3B is a more detailed illustration of garment variational autoencoder 122, according to various embodiments. As shown, garment variational autoencoder 122 includes, without limitation, encoder 125 and decoder 126. Encoder 125 includes, without limitation, a downsampler 320, a multilayer perceptron 322, and a cross attention layer 324. Decoder 126 includes, without limitation, a geometry point generator 325, a multilayer perceptron 327, and a cross-attention layer 329. In operation, downsampler 320 processes garment geometry 301 and generates downsampled garment geometry 321. Multilayer perceptron 322 processes downsampled garment geometry 321 and generates downsampled garment geometry embedding 323. Cross-attention layer 324 processes downsampled garment geometry embedding 323 and garment geometry 301 and generates garment geometry embedding 303. Geometry point generator 325 generates a geometry point 326. Multi-layer perceptron 327 processes geometry point 326 and generates geometry point embedding 328. Cross-attention layer 329 processes garment geometry embedding 303 and garment point embedding 328 and generates reconstructed garment representation 304

Downsampler 320 is an application that processes garment geometry 301 and generates downsampled garment geometry 321. In some embodiments, downsampler 320 uniformly samples a fixed number (e.g., 10,000 points) of 3D points from a garment mesh surface included in garment geometry 301, resulting in a downsampled point cloud representation (e.g., downsampled garment geometry 321) of garment geometry 301.

Multilayer perceptron 322 processes downsampled garment geometry 321 and generates downsampled garment geometry embedding 323. In some embodiments, multilayer perceptron 322 includes one or more fully connected layers with nonlinear activation functions, such as Rectified Linear Unit (ReLU), Gaussian Error Linear Unit (GELU), and/or the like, that transform each sampled point in the downsampled garment geometry 321 into a higher-dimensional feature space. The resulting downsampled garment geometry embedding 323 captures local geometric properties (e.g., surface curvature, point proximity, and/or the like).

Cross-attention layer 324 processes downsampled garment geometry embedding 323 and garment geometry 301 and generates garment geometry embedding 303. In some embodiments, cross-attention layer 324 uses a cross-attention mechanism, in which query vectors derived from the downsampled garment geometry embedding 323 attends to key and value vectors derived from garment geometry 301. In some examples, the cross-attention mechanism transforms garment geometry 301 into a set of latent vectors (denoted as Z∈ [symbol] ^{512×16}), where 512 is the number of tokens and 16 is the embedding dimension per token.

Geometry point generator 325 is a module that generates geometry point 326. In some embodiments, geometry point generator 325 uniformly samples one or more 3D query points, denoted as {q_{xyz}}⊂ [symbol] ^{N×3}, where N is the number of points sampled and each point q_{xyz}=(x, y, z) represents a location in 3D space. Geometry point generator 325 samples the query points within a spatial volume that encloses the garment.

Multilayer perceptron 327 processes geometry point 326 and generates geometry point embedding 328. In some embodiments, multilayer perceptron 327 is a neural network that includes one or more fully connected layers followed by nonlinear activation functions, such as ReLU or GELU. In some embodiments, multilayer perceptron 327 processes the input geometry points 326 {q_{xyz}} ∈ [symbol] ^{N×3} individually to generate geometry point embeddings 328 {e_{q}} ∈ [symbol] ^{N×D}, where D is the embedding dimension. Geometry point embeddings 328 encode local spatial information for each sampled query point included in geometry point 326.

Cross-attention layer 329 processes garment geometry embedding 303 and geometry point embedding 328 and generates reconstructed garment surface representation 304. In some embodiments, cross-attention layer 329 uses a cross-attention mechanism in which each geometry point embedding 328 e_{q} ε [symbol] ^{D} attends to one or more garment geometry embeddings 303 {zᵢ} ∈ [symbol] ^{M×D}, where M is the number of garment tokens and D is the embedding dimension. In some embodiments, the resulting attention outputs are aggregated and passed through one or more neural network layers included in cross-attention layer 329 to predict, for each query point q_{xyz}, an unsigned distance value indicating the proximity of the query point to the garment surface. In some examples, cross-attention layer 329 generates reconstructed garment surface representation 304 as the collection of predicted distances for all query points included in geometry point embedding 328, expressed as a UDF.

### Training Garment Diffusion Model Based on Training Data

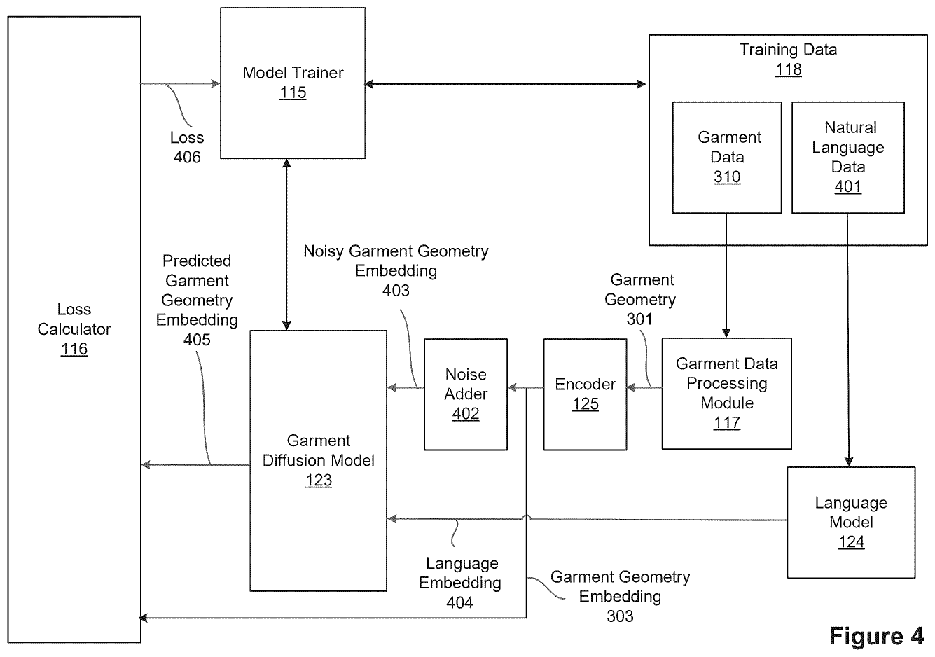

FIG. 4 illustrates how the model trainer 115 trains garment diffusion model 123, according to various embodiments. As shown, training data 119 includes, without limitation, garment data 310 and natural language data 401. Garment data processing module 117 processes garment data 310 and generates garment geometry 301. The trained encoder 125 processes garment geometry 301 and generates garment geometry embedding 303. Noise adder 402 adds noise to garment geometry embedding 303 to generate noisy garment geometry embedding 403. Language model 124 processes natural language data 401 included in training data 119 and generates language embedding 404. Garment diffusion model 123 performs one or more denoising diffusion steps to process noisy garment geometry embedding 403 and language embedding 404 to generate predicted garment geometry embedding 405. Loss calculator 116 calculates loss 406 based on predicted garment geometry embedding 405 and garment geometry embedding 303. Model trainer 115 uses loss 406 to iteratively update the parameters of garment diffusion model 123 until one or more stopping criteria are met.

Garment data processing module 117 processes garment data 310 and generates garment geometry 301. In some embodiments, garment data 310 includes 3D garment meshes, such as triangle meshes, point clouds, volumetric distance fields, and/or the like. In some embodiments, garment data processing module 117 extracts surface points from the mesh included in garment data 310 to generate garment geometry 301 as a point cloud or another suitable format.

Language model 124 is a machine learning model, such as a large language model or portion thereof, that processes natural language data 401 and generates language embedding 404. In some embodiments, natural language data 401 includes one or more text prompts, labels, or descriptions associated with a garment (e.g., “a red floral dress” or “a long-sleeved jacket”). In some embodiments, language model 124 encodes the input text included in natural language data 401 into one or more dense vectors (e.g., language embedding 404) {lᵢ}∈ [symbol] ^{L×D}, where L is the number of tokens and D is the embedding dimension (e.g., l∈ [symbol] ⁷⁶⁸). Language embedding 404 includes semantic information from natural language data 401. In some examples, language model 124 can include one or more transformer-based models, such as BERT (Bidirectional Encoder Representations from Transformers), ROBERTa (Robustly Optimized BERT Pretraining Approach), GPT-2 (Generative Pre-trained Transformer 2), GPT-3, or the text encoder component of CLIP (Contrastive Language-Image Pretraining), any of which can be pretrained or fine-tuned on domain-specific garment descriptions.

Encoder 125 processes garment geometry 301 and generates garment geometry embedding 303. In some embodiments, encoder 125 includes downsampler 320, multilayer perceptron 322, and cross attention layer 324. Downsampler 320 processes garment geometry 301 and generates downsampled garment geometry 321. Multilayer perceptron 322 processes downsampled garment geometry 321 and generates downsampled garment geometry embedding 323. Cross-attention layer 324 processes downsampled garment geometry embedding 323 and garment geometry 301 and generates garment geometry embedding 303.

Noise adder 402 is software that adds noise to garment geometry embedding 303 and generates noisy garment geometry embedding 403. In some embodiments, noise adder 402 samples a noise vector ϵ˜ [symbol] (0, σ²I), where σ is a randomly chosen noise level and I is the identity matrix. Then, noise adder 402 adds noise vector ϵ to garment geometry embedding 303 Z to generate a perturbed latent code Z′=Z+ϵ (e.g., noisy garment geometry embedding 403).

Garment diffusion model 123 is a machine learning model, such as a diffusion model, that performs one or more denoising diffusion steps to process noisy garment geometry embedding 403 and language embedding 404 to generate predicted garment geometry embedding 405. In some embodiments, garment diffusion model 123 includes an Elucidated Diffusion Model (EDM), a class of generative diffusion models optimized for sampling efficiency and perceptual quality. In some embodiments, garment diffusion model 123 includes a denoiser network [symbol] , typically implemented as a transformer-based architecture, which generates a denoised prediction of the original latent embedding (e.g., garment geometry embedding 303), for example, calculated as:

$$\hat{Z} = ( {Z}^{′} , σ , l ) , \qquad ( Equation 2 )$$

where, \hat{Z} corresponds to predicted garment geometry embedding 405.

Loss calculator 116 calculates loss 406 based on predicted garment geometry embedding 405 and garment geometry embedding 303. In some embodiments, loss 406 is calculated as a mean squared error loss between predicted embedding garment geometry embedding 405 and the original garment geometry embedding 303. In some examples, loss calculator 116 calculates loss 406 as given by

$$L ( {θ}_{D} ) = {𝔼}_{ϵ ∼ 𝒩 ( 0 , {σ}^{2} I )} {‖ 𝒟 ( Z + ϵ , σ , e ) - Z ‖}_{2}^{2} . \qquad ( Equation 3 )$$

Model trainer 115 uses loss 406 to iteratively update the parameters of garment diffusion model 123. In some embodiments, model trainer 115 uses various optimization algorithms, such as SGD or a variant thereof (e.g., Adam optimizer) to minimize loss 406 by adjusting the parameters θ_{D} of garment diffusion model 123. In some embodiments, model trainer 115 trains garment diffusion model 123 using a layer-wise training strategy. To facilitate disentanglement between garments and other components (e.g., body, hair), model trainer 115 renders and trains on separate visual layers. For example, a compound prompt included in natural language data 401, such as “Woman with long layered waves hairstyle wearing a sleeveless tea-length dress . . . ” is split into distinct prompts: “long layered waves hairstyle” which is excluded from training garment diffusion model 123, “Woman in a tank top and shorts” which is excluded from training garment diffusion model 123, and “a sleeveless tea-length dress with a gathered waist . . . ” which is used for training garment diffusion model 123. In some embodiments, model trainer 115 supports garment-focused disentanglement by rendering zoomed-in garment views (e.g., waist, sleeves, hemline) and pairing the zoomed-in garment views with garment-specific prompts included in natural language data 401. For example, when zooming in on the neckline and sleeve region, model trainer 115 uses a targeted prompt, such as “a butterfly print on the neckline and sleeves.”, which helps garment diffusion model 123 learn region-specific garment geometry 301. In some embodiments, model trainer 115 uses prompt engineering to enhance the conditioning signal (e.g., language embedding 404) provided to garment diffusion model 123. The prompt engineering includes designing garment-only prompts that avoid entangling garment geometry with non-garment features (e.g., hair, body shape). For example, the prompt “buzz cut, bold forehead” is excluded from training garment diffusion model 123. By restricting training to garment-appropriate prompts included in natural language data 401, garment diffusion model 123 more reliably associates predicted garment geometry embedding 405 with language embedding 404. Model trainer 115 continues training garment diffusion model 123 until one or more stopping criteria are satisfied, such as convergence of the loss value or reaching a predefined number of training iterations. Once model trainer 115 trains garment diffusion model 123, model trainer 115 stores the trained garment diffusion model 123 in datastore 120 or elsewhere.

### Generating A Virtual Character Using Trained Decoder and Trained Garment Diffusion Model

FIG. 5 is a more detailed illustration of character generation application 146 of FIG. 1, according to various embodiments. As shown, character generation application 146 includes, without limitation, character appearance optimizer 147, body geometry generator 148, hair geometry generator 149, and garment geometry generator 150. Garment geometry generator 150 includes, without limitation, the trained garment diffusion model 123 and the trained decoder 126. In operation, language model 124 processes natural language input 501 and generates language embedding 502. Hair geometry generator 149 processes language embedding 502 and generates hair geometry 503. Body geometry generator 148 processes language embedding 502 and generates body geometry 504. The trained garment diffusion model 123 processes language embedding 502 and generates predicted garment geometry embedding 506. The trained decoder 126 processes the predicted garment geometry embedding 506 and generates reconstructed garment surface representation 304. Garment geometry generator 150 processes reconstructed garment surface representation 304 and generates garment geometry 505. Character appearance optimizer 147 uses one or more Gaussians 506 to generate an optimized character appearance based on hair geometry 503, body geometry 504, garment geometry 505, and natural language input 501. Character generation application 146 processes the character appearance and generates virtual character 160.

Language model 124 processes natural language input 501 and generates language embedding 404. In some embodiments, language model 124 receives natural language input 501 from one or more I/O devices (e.g., input devices 258). In some embodiments, natural language input 501 includes, without limitation, textual descriptions associated with different components of a virtual character, such as garments (e.g., “a sleeveless floral maxi dress”), hair (e.g., “long wavy black hair with side part”), body appearance (e.g., “a muscular male torso” or “a child with short limbs and round face”), and/or character names. In some embodiments, natural language input 501 describes various properties, such as style, color, material, texture, and/or physical proportions, and can be paired with a specific character identity to influence the generation of character-specific features. Language model 124 processes the text descriptions included in natural language input 501 and generates corresponding language embedding 502. In some embodiments, language Model 124 includes a pretrained transformer-based model, such as BERT, GPT, or another large language model (LLM).

Hair geometry generator 149 is a module of character generation application 146 that processes language embedding 502 and generates hair geometry 503. In some embodiments, hair geometry generator 149 processes language embedding 502 and generates a three-dimensional geometric representation of hair strands or hair volume for virtual character 160. In some embodiments, hair geometry 503 is represented using a strand-based structure to capture the thin and layered nature of hair. In some examples, hair geometry 503 includes a point cloud h₀ ∈ [symbol] , where Nₛ is the number of hair strands and Nₗ is the number of line segments per strand. Each line segment defines a portion of a strand in 3D space. In some embodiments, hair geometry generator 149 includes a machine learning model trained on paired datasets of language descriptions and corresponding strand-based 3D hair data.

Body geometry generator 148 is a module of character generation application 146 that processes language embedding 502 and generates body geometry 504. In some embodiments, language embedding 502 includes natural language descriptions that pertain to human body attributes, such as pose, shape, posture, body type, and/or specific actions (e.g., “standing upright with arms slightly raised” or “sitting with legs crossed”). Body geometry 504 includes a 3D mesh, point cloud, or parametric model representing the structure of the character body. In some embodiments, body geometry generator 148 generates body geometry 504 in the form of a parameterized mesh, such as Skinned Multi-Person Linear (SMPL) or SMPL-X, allowing for expressive body shape and pose variations. In some examples, the SMPL mesh is defined as Ω=LBS(θ, β), where θ and β are the SMPL pose and shape parameters, and LBS is the linear blend skinning function.

Garment geometry generator 150 is a module of character generation application 146 that uses the trained garment diffusion model 123 and the trained decoder 126 to process language embedding 502 and generates garment geometry 505. In some embodiments, the trained garment diffusion model 123 processes language embedding 502 and generates predicted garment geometry embedding 506. The trained decoder 126 processes the predicted garment geometry embedding 506 and generates reconstructed garment surface representation 304. Garment geometry generator 150 processes reconstructed garment surface representation 304 and generates garment geometry 505. In some embodiments, garment geometry generator 150 converts the UDF included in reconstructed surface representation 304 into a triangular mesh representation included in garment geometry 505, referred to as meshUDF, by applying a surface extraction algorithm, such as Marching Cubes, Dual Contouring, or the like.

Character appearance optimizer 147 is a module of character generation application 146 that uses one or more Gaussians 506 to generate optimized character appearance based on hair geometry 503, body geometry 504, garment geometry 505, and natural language input 501. In some embodiments, character appearance optimizer 147 attaches 3D Gaussians 506 to each component, such as hair geometry 503, body geometry 504, and garment geometry 505, and optimizes the attributes of Gaussians 506 using one or more foundational diffusion models. In some embodiments, character appearance optimizer 147 associates each Gaussian 506 Gᵢ={μᵢ, rᵢ, sᵢ, fᵢ, oᵢ} with a face of the mesh [symbol] and defines a position μᵢ ∈ [symbol] ³, a rotation rᵢ ∈ [symbol] ³, and a scaling sᵢ ∈ [symbol] ³ in a local coordinate of the face of virtual character 160, as well as a color features fᵢ ∈ [symbol] ^{d}^{_{c}} and an opacity oᵢ, where d_{c} is the dimension of one or more spherical harmonic coefficients. In some embodiments, the coordinate {P(θ), R(θ), k} of the face of virtual character 160 is defined such that the origin P(θ)∈ [symbol] ³ is computed as the mean position of the face vertices, and the rotation matrix R(θ) ∈ [symbol] ^{3×3} is formed by concatenating one edge vector of the face, the normal vector, and the cross product of the edge vector and the normal vector. In some embodiments, character appearance optimizer 147 also computes a scalar k by the mean length of the edges. In some examples, character appearance optimizer 147 computes the global Gaussian position, rotation, and scale {\hat{μ}ᵢ, \hat{r}ᵢ, ŝᵢ} by applying the local-to-global transform:

$$\begin{matrix}{\hat{μ}}_{i} ( θ ) = k R ( θ ) \cdot {p}_{i} + P ( θ ) \\ {\hat{r}}_{i} ( θ ) = R ( θ ) \cdot {r}_{i} \\ {\hat{s}}_{i} ( θ ) = k {s}_{i}\end{matrix} , \qquad ( Equation 4 )$$

In some embodiments, character appearance optimizer 147 initializes the 3D Gaussians 506 by uniformly sampling points on the mesh surface, and the face correspondences are maintained throughout the Gaussian densification process. In some embodiments, character appearance optimizer 147 uses an implicit field [symbol] _{φ} with parameters φ to model the attributes of Gaussians 506. Character appearance optimizer 147 queries the color features fᵢ, opacity oᵢ of each Gaussian 506 using the global position \hat{p}ᵢ(\tilde{θ}) of that Gaussian 506 under a canonical pose \tilde{θ} by (fᵢ, oᵢ)= [symbol] _{φ} (\hat{μ}ᵢ(\tilde{θ})). In some embodiments, character appearance optimizer 147 learns two separate implicit fields for the body

$${ℱ}_{ϕ}^{b}$$

and garment

$${ℱ}_{ϕ}^{g}$$

to prevent texture entanglement. In some embodiments, the canonical garment mesh includes a garment draped on the SMPL body in T-pose. Hence, the 3D Gaussians 506 attached to the body or garment mesh can be smoothly driven as described by Equation 4. In some embodiments, to encourage the 3D Gaussians 506 to capture pose-independent albedo without baked-in shading, character appearance optimizer 147 uses a Phong shading model. Since the normal for each Gaussian 506 is noisy, character appearance optimizer 147 instead uses the normal of the corresponding face of the normal (denoted as nₚ) in the lighting model. To mimic random lighting, character appearance optimizer 147 samples the point light position [symbol] ∈ [symbol] ³, color [symbol] ∈ [symbol] ³, as well as an ambient light color [symbol] ∈ [symbol] ³. In some examples, the shaded color of each 3D Gaussian 506 can be computed by

$${f}_{i}^{′} = {f}_{i} \cdot ( max ( 0 , {n}_{p} \cdot ( {l}_{p} - {\hat{μ}}_{i} ) / ‖ {l}_{p} - {\hat{μ}}_{i} ‖ ) \cdot {l}_{c} + {l}_{a} ) , \qquad ( Equation 5 )$$

where \hat{μ}ᵢ is the global coordinate of each Gaussian 506 computed by Equation 4. In some embodiments, character appearance optimizer 147 optimizes character appearance by learning the implicit fields for the hair, body, and garment parts of virtual character 160. In some embodiments, character appearance optimizer 147 uses a Score Distillation Sampling (SDS) loss to optimize the appearance of virtual character 160, such as hair, body, and garment components-by supervising the rendered outputs against textual prompts using a pre-trained text-to-image diffusion model. In some embodiments, the hair, body, and garment of a virtual character are optimized separately based on different portions of a textual prompt corresponding to the hair, body, and garment, respectively. In some embodiments, optimization is performed over the parameters η, which include all learnable implicit fields, such as the parameters representing the hair

$$( {ℱ}_{ϕ}^{h} ) ,$$

body

$$( {ℱ}_{ϕ}^{b} ) ,$$

and garment

$$( {ℱ}_{ϕ}^{g} ) .$$

To apply the SDS loss, an image I(η) is first rendered using the current parameters. Noise ϵ is then added to simulate a denoising diffusion step, generating a noised image Iₜ. Character appearance optimizer 147 uses the text-to-image diffusion model to process the text prompt [symbol] included in natural language input 501, timestep t, and the noised image, to predict the denoised result \hat{ϵ}(Iₜ; [symbol] , t). Character appearance optimizer 147 then calculates the SDS loss by comparing the predicted noise with the actual added noise, weighted by a function w(t), and backpropagated through the rendering process to update the parameters η. In some examples, character appearance optimizer 147 calculates the gradient of the SDS loss as given by:

$${∇}_{η} {ℒ}_{S D S} = {𝔼}_{t , ε} [ w ( t ) ( \hat{ϵ} ( {I}_{{t}^{;}} 𝒯 , t ) - ϵ ) \frac{\partial I}{\partial η} ] . \qquad ( Equation 6 )$$

In some embodiments, character appearance optimizer 147 uses an additional regularization term [symbol] ₕₐᵢᵣ to further improve the quality of hair geometry 503 and mitigate broken hair artifacts caused by transparency in midstrand Gaussians 506. The regularization term permits that the opacities of Gaussians 506 gradually change along the hair strand, typically assigning higher opacity values near the scalp (roots) and lower values toward the hair ends. In some examples, given the hair point cloud h₀ ∈ [symbol] included in hair geometry 503, where Nₛ is the number of hair strands and [symbol] is the number of line segments per strand, character appearance optimizer 147 uses the following regularization term to optimize the opacity values o∈ [symbol] :

$${ℒ}_{hair} = \frac{1}{{N}_{s} {N}_{l}} {\sum }_{i = 1}^{{N}_{s}} {\sum }_{j = 2}^{{N}_{l}} ( {0}_{i , j - 1} - {0}_{i , j} ) , \qquad ( Equation 7 )$$

In some embodiments, character appearance optimizer 147 uses a final objective L=L_{SDS}+λₕₐᵢᵣ Lₕₐᵢᵣ, where λₕₐᵢᵣ is empirically set (e.g., 1.0).

In some embodiments, character generation application 146 processes the optimized character appearance and generates virtual character 160 by simulating the physical dynamics of body, garment, and hair. In some embodiments, to simulate garment motion, character generation application 146 uses a neural simulator, such as Hierarchical Graphs for Generalized Modelling of Clothing Dynamics (HOOD), to generate a garment mesh sequence based on an initial garment mesh included in garment geometry 505 and a target body pose sequence. HOOD first infers the SMPL body mesh corresponding to the SMPL parameters, treats the body mesh as obstacles, and applies a graph neural network (GNN) to predict the physical status, such as position or velocity, of each garment vertex. The physical status yields a time-varying simulated garment mesh sequence [symbol] ={g₁, . . . , gₙ}. Given a target pose sequence [symbol] ={p₁, . . . , pₙ}, the body mesh is deformed using linear blend skinning. Character generation application 146 then uses advanced physics-based simulators to simulate garment and hair to enable dynamic motion in virtual character 160. For hair, character generation application 146 uses the hair strands h₀, the target body mesh sequence [symbol] , and the simulated garment sequence G. At each timestep, the body and garment meshes are treated as obstacles, and a dedicated hair simulator generates the animated hair strand sequence [symbol] ={h₁, . . . , hₙ} of virtual character 160. In some embodiments, the simulated hair strand sequences serve as strong priors to animate the attached 3D Gaussians 506, permitting high fidelity dynamic motion for hair strands of virtual character 160 under various physical interactions. By combining garment, hair, and body simulations, character generation application 146 generates the complete animated virtual character 160 with realistic motion and detail fidelity.

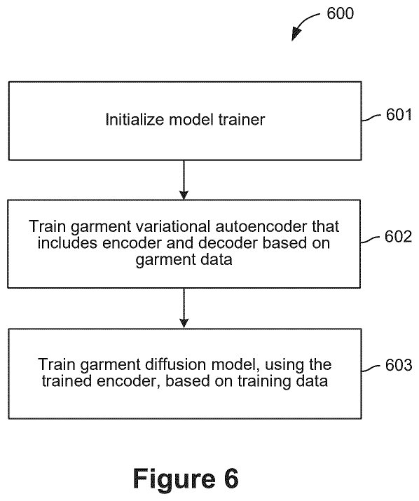

FIG. 6 is a flow diagram of method steps for training garment variational autoencoder 122 and garment diffusion model 123, according to various embodiments. Although the method steps are described in conjunction with the systems of FIGS. 1-5, persons skilled in the art will understand that any system configured to perform the method steps in any order falls within the scope of the present disclosure.

As shown, a method 600 begins with step 601, wherein model trainer 115 is initialized. In some embodiments, model trainer 115 initializes the values for the parameters of the optimization algorithm, such as learning rate, weight decay, and momentum. In some embodiments, model trainer 115 initializes the weights and biases of the neural network layers included in garment variational autoencoder 122 and garment diffusion model 123 using techniques, such as Xavier or Kaiming initialization. Model trainer 115 also allocates memory for gradient storage, establishes random seeds for reproducibility, and configures training hyperparameters, including batch size, number of epochs, and/or gradient clipping thresholds. In some embodiments, when training is resumed from a checkpoint, model trainer 115 loads the saved model parameters and optimizer states to continue training from a previous state.

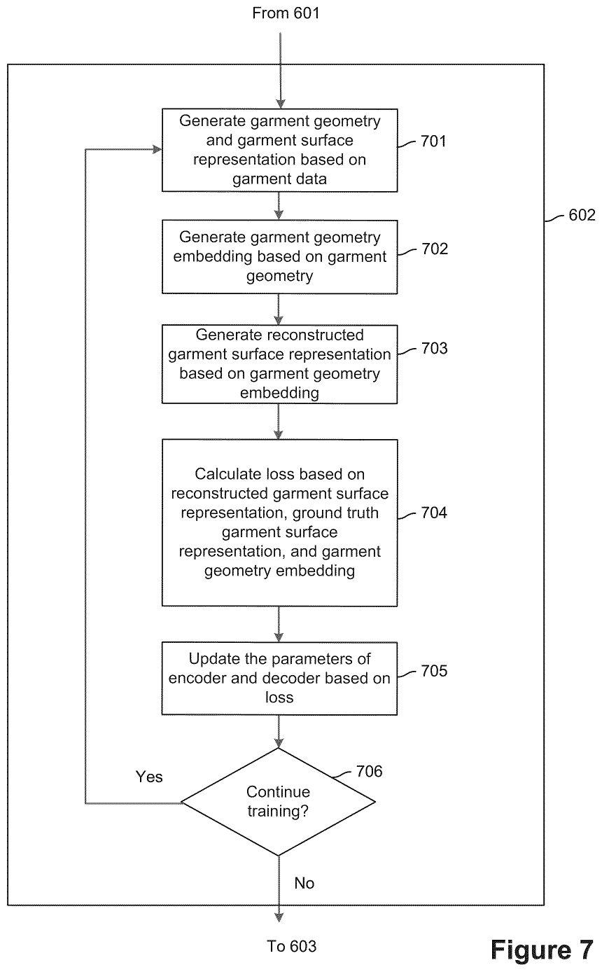

At step 602, model trainer 115 trains garment variational autoencoder 122 that includes encoder 125 and decoder 126 based on garment data 310. In some embodiments, garment data processing module 117 processes garment data 310 and generates garment geometry 301 and a garment surface representation 306. Encoder 125 processes garment geometry 301 and generates garment geometry embedding 303. Decoder 126 processes garment geometry embedding 303 and generates reconstructed garment surface representation 304. Loss calculator 116 calculates loss 305 based on reconstructed garment geometry 304, garment surface representation 306, and garment geometry embedding 303. Model trainer 115 uses loss 305 to update the parameters of garment variational autoencoder 122 until one or more stopping criteria are met. Once model trainer 115 trains garment variational autoencoder 122, model trainer 115 stores the trained garment variational autoencoder 122 in datastore 120 or elsewhere. Step 602 is described in greater detail in conjunction with FIGS. 7-9.

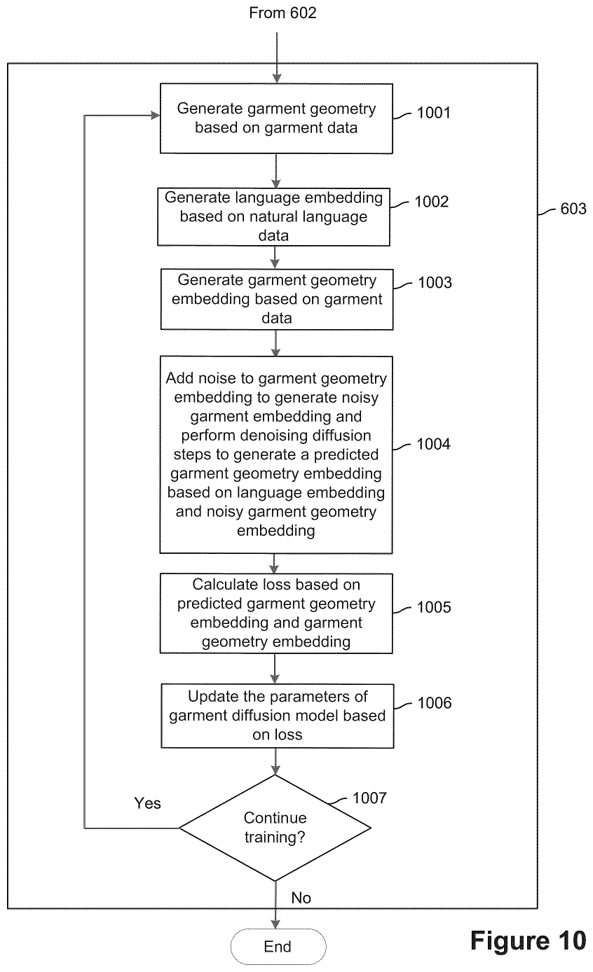

At step 603, model trainer 115 trains garment diffusion model 123, using the trained encoder 125, based on training data 118. In some embodiments, garment data processing module 117 processes garment data 310 and generates garment geometry 301. The trained encoder 125 processes garment geometry 301 and generates garment geometry embedding 303. Noise adder 402 adds noise to garment geometry embedding 303 to generate noisy garment geometry embedding 403. Language model 124 processes natural language data 401 included in training data 119 and generates language embedding 404. Garment diffusion model 123 performs one or more denoising diffusion steps to process noisy garment geometry embedding 403 and language embedding 404 to generate predicted garment geometry embedding 405. Loss calculator 116 calculates loss 406 based on predicted garment geometry embedding 405 and garment geometry embedding 303. Model trainer 115 uses loss 406 to iteratively update the parameters of garment diffusion model 123 until one or more stopping criteria are met. Once model trainer 115 trains garment diffusion model 123, model trainer 115 stores the trained garment diffusion model 123 in datastore 120 or elsewhere. Step 603 is described in greater detail in conjunction with FIG. 10.

FIG. 7 is a flow diagram of method steps for training encoder 125 and decoder 126, according to various embodiments. Although the method steps are described in conjunction with the systems of FIGS. 1-5, persons skilled in the art will understand that any system configured to perform the method steps in any order falls within the scope of the present disclosure.

As shown, the step 602 begins with step 701, where garment data processing module 117 generates garment geometry 301 and garment surface representation 306 based on garment data 310. In some embodiments, garment data processing module 117 extracts surface points from the 3D garment mesh included in garment data 310 to generate garment geometry 301 as a point cloud or another suitable format. In some embodiments, garment data processing module 117 generates garment surface representation 306 by uniformly sampling a set of 3D query points within a bounding box that fully encloses the 3D garment mesh and, for each query point, computing the unsigned Euclidean distance (e.g., UDF) to the closest surface point on the 3D garment mesh. In some embodiments, the UDF is thresholded to assign a binary label to each query point indicating whether the point lies within a specified distance of the garment surface.

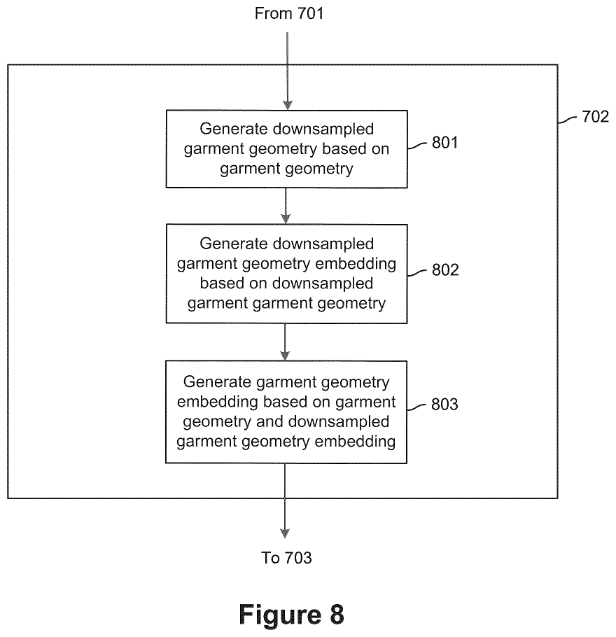

At step 702, encoder 125 generates garment geometry embedding 303 based on garment geometry 301. In some embodiments, encoder 125 includes downsampler 320, multilayer perceptron 322, and cross attention layer 324. Downsampler 320 processes garment geometry 301 and generates downsampled garment geometry 321. Multilayer perceptron 322 processes downsampled garment geometry 321 and generates downsampled garment geometry embedding 323. Cross-attention layer 324 processes downsampled garment geometry embedding 323 and garment geometry 301 and generates garment geometry embedding 303. Step 702 is described in greater detail in conjunction with FIG. 8.

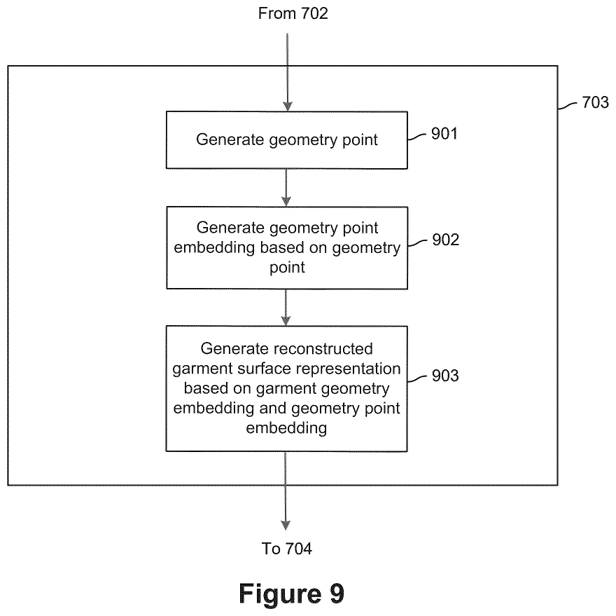

At step 703, decoder 126 generates reconstructed garment surface representation 304 based on garment geometry embedding 303. In some embodiments, decoder 126 includes geometry point generator 325, multilayer perceptron 327, and cross-attention layer 329. Geometry point generator 325 generates a geometry point 326. Multi-layer perceptron 327 processes geometry point 326 and generates geometry point embedding 328. Cross-attention layer 329 processes garment geometry embedding 303 and garment point embedding 328 and generates reconstructed garment representation 304. Step 703 is described in greater detail in conjunction with FIG. 9.

At step 704, loss calculator 116 calculates loss 305 based on reconstructed garment surface representation 304, ground truth garment surface representation 306, and garment geometry embedding 303. In some embodiments, loss calculator 116 calculates a binary cross-entropy loss based on the predicted UDF included in reconstructed garment surface representation 304 and ground truth UDF included in garment surface representation 306. In some embodiments, loss calculator 116 calculates an L2 loss between the spatial gradients of the predicted distance fields included in reconstructed garment surface representation 304 and ground truth distance fields included in garment surface representation 306 at the query points to permit geometric smoothness. In some embodiments, loss calculator 116 calculates a KL divergence loss on the latent variables included in garment geometry embedding 303 to regularize the latent space during training. In some embodiments, loss calculator 116 calculates loss 305 based on the binary cross-entropy loss, the L2 gradient loss, and the KL divergence loss. For example, loss calculator 116 can calculate loss 305 according to the formula in Equation 1.

At step 705, model trainer 115 updates the parameters of encoder 125 and decoder 126 based on loss 305. In some embodiments, model trainer 115 uses loss 305 to perform backpropagation and update the trainable parameters of garment variational autoencoder 122 using an optimization algorithm, such as SGD, Adam, and/or the like.

At step 706, model trainer 115 determines whether to continue training. In some embodiments, model trainer 115 updates the parameters of garment variational autoencoder 122 iteratively until one or more stopping criteria are met, such as a fixed number of epochs, convergence of loss 305, and/or the like. Whenever model trainer 115 determines to continue training, step 602 returns to step 701. Whenever model trainer 115 determines not to continue training, the method 600 proceeds to step 603.

FIG. 8 is a flow diagram of method steps for a generating garment geometry embedding, according to various embodiments. Although the method steps are described in conjunction with the systems of FIGS. 1-5, persons skilled in the art will understand that any system configured to perform the method steps in any order falls within the scope of the present disclosure.

As shown, the step 702 begins with step 801, where downsampler 320 generates downsampled garment geometry 321 based on garment geometry 301. In some embodiments, downsampler 320 uniformly samples a fixed number (e.g., 10,000 points) of 3D points from a garment mesh surface included in garment geometry 301, resulting in a downsampled point cloud representation (e.g., downsampled garment geometry 321) of garment geometry 301.

At step 802, multilayer perceptron 322 generates downsampled garment geometry embedding 323 based on downsampled garment garment geometry 321. In some embodiments, multilayer perceptron 322 includes one or more fully connected layers with nonlinear activation functions, such as ReLU, GELU, and/or the like, that transform each sampled point in the downsampled garment geometry 321 into a higher-dimensional feature space.

At step 803, cross-attention layer 324 generates garment geometry embedding 303 based on garment geometry 301 and downsampled garment geometry embedding 323. In some embodiments, cross-attention layer 324 uses a cross-attention mechanism, in which query vectors derived from the downsampled garment geometry embedding 323 attends to key and value vectors derived from garment geometry 301. In some examples, the cross-attention mechanism transforms garment geometry 301 into a set of latent vectors (denoted as Z∈ [symbol] ^{512×16}).

FIG. 9 is a flow diagram of method steps for generating a reconstructed garment surface representation, according to various embodiments. Although the method steps are described in conjunction with the systems of FIGS. 1-5, persons skilled in the art will understand that any system configured to perform the method steps in any order falls within the scope of the present disclosure.

As shown, the step 703 begins with step 901, where geometry point generator 325 generates geometry point 326. In some embodiments, geometry point generator 325 uniformly samples one or more 3D query points, denoted as {q_{xyz}}⊂ [symbol] ^{N×3}, where each point q_{xyz}=(x, y, z) represents a location in 3D space. Geometry point generator 325 samples the query points within a spatial volume that encloses the garment.

At step 902, multilayer perceptron 327 generates geometry point embedding 328 based on geometry point 326. In some embodiments, multilayer perceptron 327 is a neural network that includes one or more fully connected layers followed by nonlinear activation functions, such as ReLU or GELU. In some embodiments, multilayer perceptron 327 processes the input geometry points 326 {q_{xyz}} ∈ [symbol] ^{N×3} individually to generate geometry point embeddings 328 {e_{q}}∈ [symbol] ^{N×D}.

At step 903, cross-attention layer 329 generates reconstructed garment surface representation 304 based on garment geometry embedding 303 and geometry point embedding 328. In some embodiments, cross-attention layer 329 uses a cross-attention mechanism in which each geometry point embedding 328 e_{q} ∈ [symbol] ^{D} attends to one or more garment geometry embeddings 303 {zᵢ} ∈ [symbol] ^{M×D}. In some embodiments, the resulting attention outputs are aggregated and passed through one or more neural network layers included in cross-attention layer 329 to predict, for each query point q_{xyz}, an unsigned distance value indicating the proximity of the query point to the garment surface. In some examples, cross-attention layer 329 generates reconstructed garment surface representation 304 as the collection of predicted distances for all query points included in geometry point embedding 328, expressed as a UDF.

FIG. 10 is a flow diagram of method steps for training garment diffusion model 123, according to various embodiments. Although the method steps are described in conjunction with the systems of FIGS. 1-5, persons skilled in the art will understand that any system configured to perform the method steps in any order falls within the scope of the present disclosure.

As shown, the step 603 begins with step 1001, where garment data processing module 117 generates garment geometry 301 based on garment data 310. In some embodiments, garment data 310 includes 3D garment meshes, such as triangle meshes, point clouds, volumetric distance fields, and/or the like. In some embodiments, garment data processing module 117 extracts surface points from the mesh included in garment data 310 to generate garment geometry 301 as a point cloud or another suitable format.

At step 1002, language model 124 generates language embedding 404 based on natural language data 401. In some embodiments, language model 124 encodes the input text included in natural language data 401 into one or more dense vectors (e.g., language embedding 404) {lᵢ} ∈ [symbol] ^{L×D}, where L is the number of tokens and D is the embedding dimension (e.g., l∈ [symbol] ⁷⁶⁸). In some examples, language model 124 can include one or more transformer-based models, such as BERT, ROBERTa, GPT-2, GPT-3, or the text encoder component of CLIP, any of which can be pretrained or fine-tuned on domain-specific garment descriptions.

At step 1003, encoder 125 generates garment geometry embedding 303 based on garment geometry 301. In some embodiments, encoder 125 includes downsampler 320, multilayer perceptron 322, and cross attention layer 324. Downsampler 320 processes garment geometry 301 and generates downsampled garment geometry 321. Multilayer perceptron 322 processes downsampled garment geometry 321 and generates downsampled garment geometry embedding 323. Cross-attention layer 324 processes downsampled garment geometry embedding 323 and garment geometry 301 and generates garment geometry embedding 303.

At step 1004, noise adder 402 adds noise to garment geometry embedding 303 to generate noisy garment embedding 403, and garment diffusion model 123 performs denoising diffusion steps to generate a predicted garment geometry embedding 405 based on language embedding 404 and noisy garment geometry embedding 403. In some embodiments, noise adder 402 samples a noise vector ϵ˜ [symbol] (0, σ²I), where σ is a randomly chosen noise level and I is the identity matrix. Then, noise adder 402 adds noise vector ϵ to garment geometry embedding 303 Z to generate a perturbed latent code Z′=Z+ϵ (e.g., noisy garment geometry embedding 403). In some embodiments, garment diffusion model 123 includes an EDM, a class of generative diffusion models optimized for sampling efficiency and perceptual quality. In some embodiments, garment diffusion model 123 includes a denoiser network [symbol] , typically implemented as a transformer-based architecture, which generates a denoised prediction of the original latent embedding (e.g., garment geometry embedding 303), for example, calculated as described in Equation 2.

At step 1005, loss calculator 116 calculates loss 406 based on predicted garment geometry embedding 405 and garment geometry embedding 303. In some embodiments, loss 406 is calculated as a mean squared error loss between predicted embedding garment geometry embedding 405 and the original garment geometry embedding 303. In some examples, loss calculator 116 calculates loss 406 as given by Equation 3.

At step 1006, model trainer 115 updates the parameters of garment diffusion model 123 based on loss 406. In some embodiments, model trainer 115 uses various optimization algorithms, such as SGD or a variant thereof (e.g., Adam optimizer) to minimize loss 406 by adjusting the parameters θ_{D} of garment diffusion model 123. In some embodiments, model trainer 115 trains garment diffusion model 123 using a layer-wise training strategy. To facilitate disentanglement between garments and other components (e.g., body, hair), model trainer 115 renders and trains on separate visual layers. In some embodiments, model trainer 115 supports garment-focused disentanglement by rendering zoomed-in garment views (e.g., waist, sleeves, hemline) and pairing the zoomed-in garment views with garment-specific prompts included in natural language data 401. In some embodiments, model trainer 115 uses prompt engineering to enhance the conditioning signal (e.g., language embedding 404) provided to garment diffusion model 123. The prompt engineering includes designing garment-only prompts that avoid entangling garment geometry with non-garment features (e.g., hair, body shape). By restricting training to garment-appropriate prompts included in natural language data 401, garment diffusion model 123 more reliably associates predicted garment geometry embedding 405 with language embedding 404.

At step 1007, model trainer 115 determines whether to continue training. Model trainer 115 continues training garment diffusion model 123 until one or more stopping criteria are satisfied, such as convergence of the loss value or reaching a predefined number of training iterations. Whenever model trainer 115 determines to continue training, the step 603 returns to step 1001. Whenever model trainer 115 determines not to continue training, the method 600 terminates.

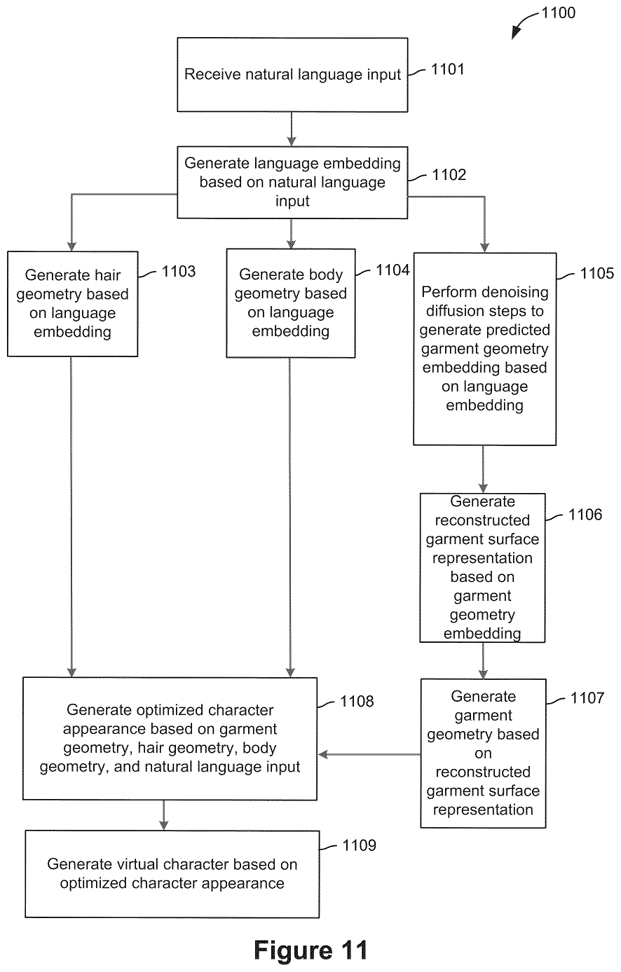

FIG. 11 is the flow diagram of method steps for generating virtual character 160, according to various embodiments. Although the method steps are described in conjunction with the systems of FIGS. 1-5, persons skilled in the art will understand that any system configured to perform the method steps in any order falls within the scope of the present disclosure.

As shown, a method 1100 begins with step 1101, where language model 124 and character appearance optimizer 147 receive natural language input 501. In some embodiments, language model 124 and character appearance optimizer 147 receive natural language input 501 from one or more I/O devices (e.g., input devices 258). In some embodiments, natural language input 501 includes, without limitation, textual descriptions associated with different components of a virtual character, such as garments (e.g., “a sleeveless floral maxi dress”), hair (e.g., “long wavy black hair with side part”), body appearance (e.g., “a muscular male torso” or “a child with short limbs and round face”), and/or character names. In some embodiments, natural language input 501 describes various properties, such as style, color, material, texture, and/or physical proportions, and can be paired with a specific character identity to influence the generation of character-specific features.

At step 1102, language model generates language embedding 502 based on natural language input 501. In some embodiments, language model 124 processes the text descriptions included in natural language input 501 and generates corresponding language embedding 502. In some embodiments, language Model 124 includes a pretrained transformer-based model, such as BERT, GPT, or another LLM.

At step 1103, hair geometry generator 149 generates hair geometry 503 based on language embedding 502. In some embodiments, hair geometry generator 149 processes language embedding 502 and generates a three-dimensional geometric representation of hair strands or hair volume for virtual character 160. In some embodiments, hair geometry 503 is represented using a strand-based structure to capture the thin and layered nature of hair. In some examples, hair geometry 503 includes a point cloud h₀ ∈ [symbol] . In some embodiments, hair geometry generator 149 includes a machine learning model trained on paired datasets of language descriptions and corresponding strand-based 3D hair data.

At step 1104, body geometry generator 148 generates body geometry 504 based on language embedding 502. In some embodiments, language embedding 502 includes natural language descriptions that pertain to human body attributes, such as pose, shape, posture, body type, and/or specific actions (e.g., “standing upright with arms slightly raised” or “sitting with legs crossed”). In some embodiments, body geometry generator 148 generates body geometry 504 in the form of a parameterized mesh, such as SMPL or SMPL-X, allowing for expressive body shape and pose variations. In some examples, the SMPL mesh is defined as Ω=LBS (θ, β), where θ and β are the SMPL pose and shape parameters, and LBS is the linear blend skinning function.

At step 1105, the trained garment diffusion model 123 performs denoising diffusion steps to generate predicted garment geometry embedding 506 based on language embedding 502. In some embodiments, garment diffusion model 123 includes an EDM. In some embodiments, garment diffusion model 123 includes a denoiser network D, typically implemented as a transformer-based architecture, which generates a denoised prediction of the original latent embedding, for example, calculated as described in Equation 2.

At step 1106, the trained decoder 126 generates reconstructed garment surface representation 304 based on garment geometry embedding 506. In some embodiments, decoder 126 includes geometry point generator 325, multilayer perceptron 327, and cross-attention layer 329. Geometry point generator 325 generates a geometry point 326. Multi-layer perceptron 327 processes geometry point 326 and generates geometry point embedding 328. Cross-attention layer 329 processes garment geometry embedding 303 and garment point embedding 328 and generates reconstructed garment representation 304.

At step 1107, garment geometry generator 150 generates garment geometry 505 based on reconstructed garment surface representation 304. In some embodiments, garment geometry generator 150 converts the UDF included in reconstructed surface representation 304 into a triangular mesh representation included in garment geometry 505, referred to as meshUDF, by applying a surface extraction algorithm, such as Marching Cubes, Dual Contouring, or the like. In some embodiments, steps 1103-1104 and steps 1105-1107 can be performed concurrently or sequentially.

At step 1108, character appearance optimizer 147 generates an optimized character appearance based on garment geometry 505, hair geometry 503, body geometry 504, and natural language input 501. In some embodiments, character appearance optimizer 147 attaches 3D Gaussians 506 to each component, such as hair geometry 503, body geometry 504, and garment geometry 505, and optimizes the attributes of Gaussians 506 using one or more foundational diffusion models. In some embodiments, character appearance optimizer 147 associates each Gaussian 506 Gᵢ={μᵢ, rᵢ, sᵢ, fᵢ, oᵢ} with a face of the mesh [symbol] and defines a position μᵢ∈ [symbol] ³, a rotation rᵢ∈ [symbol] ³, and a scaling sᵢ ∈ [symbol] ³ in a local coordinate of the face of virtual character 160, as well as a color features fᵢ ∈ [symbol] ^{d}^{_{c}} and an opacity oᵢ, where d_{c} is the dimension of one or more spherical harmonic coefficients. In some embodiments, the coordinate {P(θ), R(θ), k} of the face of virtual character 160 is defined such that the origin P(θ)∈ [symbol] ³ is computed as the mean position of the face vertices, and the rotation matrix R(θ)∈ [symbol] ^{3×3} is formed by concatenating one edge vector of the face, the normal vector, and the cross product of the edge vector and the normal vector. In some embodiments, character appearance optimizer 147 also computes a scalar k by the mean length of the edges. In some examples, character appearance optimizer 147 computes the global Gaussian position, rotation, and scale {\hat{μ}ᵢ, \hat{r}ᵢ, ŝᵢ} by applying the local-to-global transform described in Equation 4. In some embodiments, character appearance optimizer 147 initializes the 3D Gaussians 506 by uniformly sampling points on the mesh surface, and the face correspondences are maintained throughout the Gaussian densification process. In some embodiments, character appearance optimizer 147 uses an implicit field [symbol] _{φ} with parameters φ to model the attributes of Gaussians 506. Character appearance optimizer 147 queries the color features fᵢ, opacity oᵢ of each Gaussian 506 using the global position \hat{p}ᵢ(\tilde{θ}) of that Gaussian 506 under a canonical pose \tilde{θ} by (fᵢ, oᵢ)= [symbol] _{φ}(\hat{μ}ᵢ(\tilde{θ})). In some embodiments, character appearance optimizer 147 learns two separate implicit fields for the body

$${ℱ}_{ϕ}^{b}$$

and garment

$${ℱ}_{ϕ}^{g}$$

to prevent texture entanglement. In some embodiments, the canonical garment mesh includes a garment draped on the SMPL body in T-pose. Hence, the 3D Gaussians 506 attached to the body or garment mesh can be smoothly driven as described by Equation 4. In some embodiments, to encourage the 3D Gaussians 506 to capture pose-independent albedo without baked-in shading, character appearance optimizer 147 uses a Phong shading model. Since the normal for each Gaussian 506 is noisy, character appearance optimizer 147 instead uses the normal of the corresponding face of the normal (denoted as nₚ) in the lighting model. To mimic random lighting, character appearance optimizer 147 samples the point light position lₚ ∈ [symbol] ³, color l_{c} ∈ [symbol] ³, as well as an ambient light color [symbol] ∈ [symbol] ³. In some examples, the shaded color of each 3D Gaussian 506 can be computed by Equation 5. In some embodiments, character appearance optimizer 147 optimizes character appearance by learning the implicit fields for the hair, body, and garment parts of virtual character 160. In some embodiments, character appearance optimizer 147 uses an SDS loss to optimize virtual character 160, such as hair, body, and garment components-by supervising the rendered outputs against textual prompts using a pre-trained text-to-image diffusion model. In some embodiments, the hair, body, and garment of a virtual character are optimized separately based on different portions of a textual prompt corresponding to the hair, body, and garment, respectively. In some embodiments, optimization is performed over the parameters η, which include all learnable implicit fields, such as the parameters representing the hair

$$( {ℱ}_{ϕ}^{h} ) ,$$

body

$$( {ℱ}_{ϕ}^{b} ) ,$$

and garment

$$( {ℱ}_{ϕ}^{g} ) .$$

To apply the SDS loss, an image I(η) is first rendered using the and garment current parameters. Noise ϵ is then added to simulate a denoising diffusion step, generating a noised image Iₜ. Character appearance optimizer 147 uses the text-to-image diffusion model to process the text prompt [symbol] included in natural language input 501, timestep t, and the noised image, to predict the denoised result \hat{ϵ}(Iₜ; [symbol] , t). Character appearance optimizer 147 then calculates the SDS loss by comparing the predicted noise with the actual added noise, weighted by a function w(t), and backpropagated through the rendering process to update the parameters η. In some examples, character appearance optimizer 147 calculates the gradient of the SDS loss as given by Equation 6. In some embodiments, character appearance optimizer 147 uses an additional regularization term [symbol] ₕₐᵢᵣ to further improve the quality of hair geometry 503 and mitigate broken hair artifacts caused by transparency in midstrand Gaussians 506. The regularization term permits that the opacities of Gaussians 506 gradually change along the hair strand, typically assigning higher opacity values near the scalp (roots) and lower values toward the hair ends. In some examples, given the hair point cloud h₀ ∈ [symbol] included in hair geometry 503, character appearance optimizer 147 uses the regularization term described in Equation 7 to optimize the opacity values o ∈ [symbol] . In some embodiments, character appearance optimizer 147 uses a final objective L=L_{SDS}+λₕₐᵢᵣ Lₕₐᵢᵣ, where λₕₐᵢᵣ is empirically set (e.g., 1.0).

At step 1109, character generation application 146 generates virtual character 160 based on the optimized character appearance. In some embodiments, character generation application 146 processes the optimized character appearance and generates virtual character 160 by simulating the physical dynamics of body, garment, and hair. In some embodiments, to simulate garment motion, character generation application 146 uses a neural simulator, such as HOOD, to generate a garment mesh sequence based on an initial garment mesh included in garment geometry 505 and a target body pose sequence. HOOD first infers the SMPL body mesh corresponding to the SMPL parameters, treats the body mesh as obstacles, and applies a GNN to predict the physical status, such as position or velocity, of each garment vertex. The physical status yields a time-varying simulated garment mesh sequence [symbol] ={g₁, . . . , gₙ}. Given a target pose sequence [symbol] ={p₁, . . . , pₙ}, the body mesh is deformed using linear blend skinning. Character generation application 146 then uses advanced physics-based simulators to simulate garment and hair to enable dynamic motion in virtual character 160. For hair, character generation application 146 uses the hair strands h₀, the target body mesh sequence [symbol] , and the simulated garment sequence G. At each timestep, the body and garment meshes are treated as obstacles, and a dedicated hair simulator generates the animated hair strand sequence [symbol] ={h₁, . . . , hₙ} of virtual character 160. In some embodiments, the simulated hair strand sequences serve as strong priors to animate the attached 3D Gaussians 506, permitting high fidelity dynamic motion for hair strands of virtual character 160 under various physical interactions. By combining garment, hair, and body simulations, character generation application 146 generates the complete animated virtual character 160 with realistic motion and detail fidelity.

In sum, techniques are disclosed for virtual character generation. In some embodiments, a model trainer trains a garment variational autoencoder and a garment diffusion model based on training data. The garment variational autoencoder is a machine learning model, which processes a garment geometry, such as a point cloud, and generates a reconstructed garment surface representation, such as an unsigned distance field (UDF) or occupancy field. In some embodiments, the garment variational autoencoder includes, without limitation, an encoder and a decoder. In some embodiments, the model trainer trains the garment variational autoencoder based on garment data included in the training data. During the training of the garment variational autoencoder, a garment data processing module processes the garment data and generates the garment geometry and a garment surface representation. The encoder, which is a machine learning model, processes the garment geometry and generates a garment geometry embedding. The decoder, which is another machine learning model, processes the garment geometry embedding and generates the reconstructed garment surface representation. A loss calculator calculates a first loss based on the reconstructed garment geometry, the garment surface representation, and the garment geometry. The model trainer uses the first loss to update the parameters of the garment variational autoencoder until one or more stopping criteria are met. Once the garment variational autoencoder is trained, the model trainer uses the trained encoder to train the garment diffusion model based on the training data. During the training of the garment diffusion model, the garment data processing module processes the garment data and generates the garment geometry. The trained encoder processes the garment geometry and generates garment geometry embeddings. A noise adder adds noise to a garment geometry embedding to generate a noisy garment geometry embedding. A language model processes natural language data included in the training data and generates a language embedding. The garment diffusion model performs one or more denoising diffusion steps to process the noisy garment geometry embedding and the language embedding to generate a predicted garment geometry embedding. The loss calculator calculates a second loss based on the predicted garment geometry embedding and the garment geometry embedding. The model trainer uses the second loss to iteratively update the parameters of the garment diffusion model until one or more stopping criteria are met.

Once the training is complete, a character generation application can use a garment geometry generator along with a body geometry generator and hair geometry generator to process a natural language input and generate a virtual character. In some embodiments, the character generation application includes, without limitation, the garment geometry generator and a character appearance optimizer. The garment geometry generator is a module that uses the trained garment diffusion model and the trained decoder to process a language embedding and generate a garment geometry. During inference, the language model processes a natural language input received from one or more I/O devices and generates the language embedding. The hair geometry generator is a module that processes the language embedding and generates hair geometry. The body geometry generator is a module that processes the language embedding and generates a body geometry. The trained garment diffusion model processes the language embedding and generates the predicted garment geometry embedding. The trained decoder processes the garment geometry embedding and generates the reconstructed garment surface representation. The garment geometry generator processes the reconstructed garment surface representation and generates the garment geometry. The character appearance optimizer is a module that uses one or more Gaussians to optimize a character appearance based on the hair geometry, the body geometry, the garment geometry, and the natural language input generating optimized character appearance. The character generation application generates a virtual character that includes the optimized character appearance, the body geometry, the hair geometry, and the garment geometry. At least one technical advantage of the disclosed techniques relative to the prior art is that the disclosed techniques eliminate the need for manually defined asset hierarchies and fixed mesh templates by introducing machine learning models, such as variational autoencoders and diffusion models, that directly learn garment, hair, and body geometry representations from data. The models are trained to generate high-fidelity surface representations conditioned on natural language prompts, enabling generalization across a wide range of character shapes, clothing styles, and appearance variations without the need for manual reauthoring or retargeting. Additionally, the disclosed techniques generate continuous surface representations, such as UDFs, that avoid the constraints of rigid skinning and deformation, allowing garments and hair to exhibit more realistic motion and interaction with physical environments or character movements. These technical advantages provide one or more technological improvements over prior art approaches.
1. In some embodiments, a computer-implemented method for training machine learning models for object generation comprises performing, based on object data, one or more operations to train an untrained machine learning model to generate a trained machine learning model that comprises a trained encoder and a trained decoder, wherein the trained machine learning model is trained to generate an object surface representation, and performing, based on the object data and natural language data, one or more operations to train an untrained diffusion model to generate a trained diffusion model, wherein the trained diffusion model is trained to generate an object geometry embedding, and wherein the trained diffusion model and the trained decoder are used to generate a virtual object based on natural language input.
2. The computer-implemented method of clause 1, wherein performing the one or more operations to train the untrained machine learning model to generate the trained machine learning model comprises generating, based on the object data, an object geometry and a first object surface representation, generating, based on the object geometry, a first object geometry embedding using an untrained encoder, generating, based on the first object geometry embedding, a reconstruction of the first object surface representation using an untrained decoder, calculating, based on the first object geometry embedding, the reconstruction of the first object surface representation, and the first object surface representation, a loss, and updating, based on the loss, one or more parameters of the untrained encoder and the untrained decoder.
3. The computer-implemented method of clauses 1 or 2, wherein the loss comprises at least one of a binary cross-entropy loss based on a predicted unsigned distance field (UDF) included in the reconstruction of the first object surface representation and a ground truth UDF included in the first object surface representation, an L2 gradient loss between one or more spatial gradients of the predicted UDF and the ground truth UDF at one or more query points, or a Kullback-Leibler (KL) divergence loss based on one or more latent variables included in the first object geometry embedding.
4. The computer-implemented method of any of clauses 1-3, wherein performing the one or more operations to generate the trained diffusion model comprises generating, based on the natural language data, a language embedding, generating, based on the object data, an object geometry, generating, based on the object geometry, a first object geometry embedding using the trained encoder, adding noise to the first object geometry embedding to generate a noisy object geometry embedding, performing one or more denoising steps, using an untrained diffusion model, to generate a predicted object geometry embedding based on the noisy object geometry embedding, calculating, based on the first object geometry embedding and the predicted object geometry embedding, a loss, and updating, based on the loss, one or more parameters of the untrained diffusion model.
5. The computer-implemented method of any of clauses 1-4, wherein the loss comprises a mean squared error loss between the predicted object geometry embedding and the first object geometry embedding.
6. The computer-implemented method of any of clauses 1-5, wherein performing the one or more operations to train the untrained diffusion model to generate the trained diffusion model comprises performing one or more layer-wise training operations to disentangle one or more objects from one or more other components.
7. The computer-implemented method of any of clauses 1-6, wherein performing the one or more layer-wise training operations comprises training one or more separate visual layers of the untrained diffusion model.
8. The computer-implemented method of any of clauses 1-7, wherein performing the one or more layer-wise training operations comprises rendering one or more zoomed-in object views, and pairing the one or more zoomed-in object views with one or more object-specific prompts included in the natural language data.
9. The computer-implemented method of any of clauses 1-8, wherein generating the virtual object comprises generating, based on the natural language input, a language embedding, and generating, based on the language embedding, an object geometry using the trained diffusion model and the trained decoder.
10. The computer-implemented method of any of clauses 1-9, further comprising generating, based on the language embedding, a body geometry, generating, based on the language embedding, a hair geometry, performing one or more optimization steps, based on the body geometry, the hair geometry, the object geometry, and the natural language input, to generate an optimized character appearance, and generating, based on the optimized character appearance, a virtual character.
11. In some embodiments, one or more non-transitory computer-readable media store instructions that, when executed by one or more processors, cause the one or more processors to perform the steps of performing, based on object data, one or more operations to train an untrained machine learning model to generate a trained machine learning model that comprises a trained encoder and a trained decoder, wherein the trained machine learning model is trained to generate an object surface representation, and performing, based on the object data and natural language data, one or more operations to train an untrained diffusion model to generate a trained diffusion model, wherein the trained diffusion model is trained to generate an object geometry embedding, wherein the trained diffusion model and the trained decoder are used to generate a virtual object based on natural language input.
12. The one or more non-transitory computer-readable media of clause 11, wherein performing the one or more operations to train the untrained machine learning model to generate the trained machine learning model comprises generating, based on the object data, an object geometry and a first object surface representation, generating, based on the object geometry, a first object geometry embedding using an untrained encoder, generating, based on the first object geometry embedding, a reconstruction of the first object surface representation using an untrained decoder, calculating, based on the first object geometry embedding, the reconstruction of the first object surface representation, and the first object surface representation, a loss, and updating, based on the loss, one or more parameters of the untrained encoder and the untrained decoder.
13. The one or more non-transitory computer-readable media of clauses 11 or 12, wherein performing the one or more operations to generate the trained diffusion model comprises generating, based on the natural language data, a language embedding, generating, based on the object data, an object geometry, generating, based on the object geometry, a first object geometry embedding using the trained encoder, adding noise to the first object geometry embedding to generate a noisy object geometry embedding, performing one or more denoising steps, using an untrained diffusion model, to generate a predicted object geometry embedding based on the noisy object geometry embedding, calculating, based on the first object geometry embedding and the predicted object geometry embedding, a loss, and updating, based on the loss, one or more parameters of the untrained diffusion model.
14. The one or more non-transitory computer-readable media of any of clauses 11-13, wherein performing the one or more operations to train the untrained diffusion model to generate the trained diffusion model comprises performing one or more layer-wise training operations to disentangle one or more objects from one or more other components.
15. The one or more non-transitory computer-readable media of any of clauses 11-14, wherein performing the one or more layer-wise training operations comprises generating one or more object-only prompts that avoid entangling an object geometry with one or more non-object geometries.
16. The one or more non-transitory computer-readable media of any of clauses 11-15, where the trained diffusion model comprises an elucidated diffusion model.
17. The one or more non-transitory computer-readable media of any of clauses 11-16, wherein generating the virtual object comprises generating, based on the natural language input, a language embedding, and generating, based on the language embedding, an object geometry using the trained diffusion model and the trained decoder.
18. The computer-implemented method of any of clauses 11-17, wherein generating the object geometry comprises generating, based on the language embedding, a predicted object geometry embedding using the trained diffusion model, generating, based on the predicted object geometry embedding, a first object surface representation, and generating, based on the first object surface representation, the object geometry.
19. The one or more non-transitory computer-readable media of any of clauses 11-18, wherein the instructions, when executed by the one or more processors, further cause the one or more processors to perform the steps of generating, based on the language embedding, a body geometry, generating, based on the language embedding, a hair geometry, performing one or more optimization steps, based on the body geometry, the hair geometry, the object geometry, and the natural language input, to generate an optimized character appearance, and generating, based on the optimized character appearance, a virtual character.
20. In some embodiments, a system comprises one or more memories storing instructions, and one or more processors that are coupled to the one or more memories and, when executing the instructions, are configured to perform, based on object data, one or more operations to train an untrained machine learning model to generate a trained machine learning model that comprises a trained encoder and a trained decoder, wherein the trained machine learning model is trained to generate an object surface representation, and perform, based on the object data and natural language data, one or more operations to train an untrained diffusion model to generate a trained diffusion model, wherein the trained diffusion model is trained to generate an object geometry embedding, wherein the trained diffusion model and the trained decoder are used to generate a virtual object based on natural language input.
1. In some embodiments, a computer-implemented method for generating a virtual object comprises processing a language embedding associated with a natural language description of an object using a trained diffusion model to generate a first object geometry embedding, processing the first object geometry embedding using a trained decoder to generate an object surface representation, and converting the object surface representation into a first object geometry of the virtual object.
2. The computer-implemented method of clause 1, further comprising generating the language embedding based on the natural language description and using a trained language model.
3. The computer-implemented method of clauses 1 or 2, wherein the trained decoder comprises a first multilayer perceptron and a first cross-attention layer.
4. The computer-implemented method of any of clauses 1-3, wherein the trained decoder is trained together with an encoder, and wherein the encoder comprises a second multilayer perceptron and a second cross attention layer.
5. The computer-implemented method of any of clauses 1-4, wherein the trained decoder is trained together with an encoder, and wherein the encoder is trained to generate a second object geometry embedding by generating, based on a second object geometry, a downsampled object geometry, generating, based on the downsampled object geometry, a downsampled object geometry embedding using a multilayer perceptron, and generating, based on the downsampled object geometry embedding and the second object geometry, the second object geometry embedding using a cross-attention layer.
6. The computer-implemented method of any of clauses 1-5, wherein generating the downsampled object geometry comprises uniformly sampling a fixed number of one or more three-dimensional points from an object mesh surface included in the second object geometry.
7. The computer-implemented method of any of clauses 1-6, wherein generating the object surface representation comprises generating a geometry point, generating, based on the geometry point, a geometry point embedding using a multilayer perceptron, and generating, based on the geometry point embedding and the first object geometry embedding, the object surface representation.
8. The computer-implemented method of any of clauses 1-7, wherein generating the geometry point comprises uniformly sampling one or more three-dimensional query points.
9. The computer-implemented method of any of clauses 1-8, wherein the first object geometry of the virtual object comprises a garment geometry associated with a virtual character.
10. The computer-implemented method of any of clauses 1-9, further comprising generating, based on the language embedding, a body geometry, generating, based on the language embedding, a hair geometry, performing one or more optimization steps, based on the body geometry, the hair geometry, the garment geometry, and the natural language description, to generate an optimized character appearance, and generating the virtual character based on the optimized character appearance, the body geometry, the hair geometry, and the garment geometry.
11. In some embodiments, one or more non-transitory computer-readable media store instructions that, when executed by one or more processors, cause the one or more processors to perform the steps of processing a language embedding associated with a natural language description of an object using a trained diffusion model to generate a first object geometry embedding, processing the first object geometry embedding using a trained decoder to generate an object surface representation, and converting the object surface representation into a first object geometry of a virtual object.
12. The one or more non-transitory computer-readable media of clause 11, wherein the trained decoder is trained together with an encoder, and the encoder is trained to generate a second object embedding by generating, based on a second object geometry, a downsampled object geometry, generating, based on the downsampled object geometry, a downsampled object geometry embedding using a multilayer perceptron, and generating, based on the downsampled object geometry embedding and the second object geometry, the second object geometry embedding using a cross-attention layer.
13. The computer-implemented method of clauses 11 or 12, wherein the second object geometry comprises a point cloud extracted from a three-dimensional object mesh.
14. The one or more non-transitory computer-readable media of any of clauses 11-13, wherein generating the object surface representation comprises generating a geometry point, generating, based on the geometry point, a geometry point embedding using a multilayer perceptron, and generating, based on the geometry point embedding and the first object geometry embedding, the object surface representation.
15. The computer-implemented method of any of clauses 11-14, wherein generating the geometry point comprises uniformly sampling one or more three-dimensional query points.
16. The computer-implemented method of any of clauses 11-15, wherein the first object geometry of the virtual object comprises a garment geometry associated with a virtual character.
17. The computer-implemented method of any of clauses 11-16, wherein the instructions, when executed by the one or more processors, further cause the one or more processors to perform the steps of generating, based on the language embedding, a body geometry, generating, based on the language embedding, a hair geometry, performing one or more optimization steps, based on the body geometry, the hair geometry, the garment geometry, and the natural language description, to generate an optimized character appearance, and generating the virtual character based on the optimized character appearance, the body geometry, the hair geometry, and the garment geometry.
18. The computer-implemented method of any of clauses 11-17, wherein performing the one or more optimization steps to generate the optimized character appearance comprises calculating a regularization term based on one or more opacities included in one or more attached Gaussians to the hair geometry.
19. The computer-implemented method of any of clauses 11-18, wherein the object surface representation comprises one or more unsigned distance values.
20. In some embodiments, a system comprises one or more memories storing instructions, and one or more processors that are coupled to the one or more memories and, when executing the instructions, are configured to process a language embedding associated with a natural language description of an object using a trained diffusion model to generate a first object geometry embedding, process the first object geometry embedding using a trained decoder to generate an object surface representation, and convert the object surface representation into a first object geometry of a virtual object.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for training machine learning models for object generation, the method comprising:
performing, based on object data, one or more operations to train an untrained machine learning model to generate a trained machine learning model that comprises a trained encoder and a trained decoder, wherein the trained machine learning model is trained to generate an object surface representation; and
performing, based on the object data and natural language data, one or more operations to train an untrained diffusion model to generate a trained diffusion model, wherein the trained diffusion model is trained to generate an object geometry embedding; and
wherein the trained diffusion model and the trained decoder are used to generate a virtual object based on natural language input.

2. The computer-implemented method of claim 1, wherein performing the one or more operations to train the untrained machine learning model to generate the trained machine learning model comprises:
generating, based on the object data, an object geometry and a first object surface representation;
generating, based on the object geometry, a first object geometry embedding using an untrained encoder;
generating, based on the first object geometry embedding, a reconstruction of the first object surface representation using an untrained decoder;
calculating, based on the first object geometry embedding, the reconstruction of the first object surface representation, and the first object surface representation, a loss; and
updating, based on the loss, one or more parameters of the untrained encoder and the untrained decoder.

3. The computer-implemented method of claim 2, wherein the loss comprises at least one of:
a binary cross-entropy loss based on a predicted unsigned distance field (UDF) included in the reconstruction of the first object surface representation and a ground truth UDF included in the first object surface representation;
an L2 gradient loss between one or more spatial gradients of the predicted UDF and the ground truth UDF at one or more query points; or
a Kullback-Leibler (KL) divergence loss based on one or more latent variables included in the first object geometry embedding.

4. The computer-implemented method of claim 1, wherein performing the one or more operations to generate the trained diffusion model comprises:
generating, based on the natural language data, a language embedding;
generating, based on the object data, an object geometry;
generating, based on the object geometry, a first object geometry embedding using the trained encoder;
adding noise to the first object geometry embedding to generate a noisy object geometry embedding;
performing one or more denoising steps, using an untrained diffusion model, to generate a predicted object geometry embedding based on the noisy object geometry embedding;
calculating, based on the first object geometry embedding and the predicted object geometry embedding, a loss; and
updating, based on the loss, one or more parameters of the untrained diffusion model.

5. The computer-implemented method of claim 4, wherein the loss comprises a mean squared error loss between the predicted object geometry embedding and the first object geometry embedding.

6. The computer-implemented method of claim 1, wherein performing the one or more operations to train the untrained diffusion model to generate the trained diffusion model comprises performing one or more layer-wise training operations to disentangle one or more objects from one or more other components.

7. The computer-implemented method of claim 6, wherein performing the one or more layer-wise training operations comprises training one or more separate visual layers of the untrained diffusion model.

8. The computer-implemented method of claim 6, wherein performing the one or more layer-wise training operations comprises:
rendering one or more zoomed-in object views; and
pairing the one or more zoomed-in object views with one or more object-specific prompts included in the natural language data.

9. The computer-implemented method of claim 1, wherein generating the virtual object comprises:
generating, based on the natural language input, a language embedding; and
generating, based on the language embedding, an object geometry using the trained diffusion model and the trained decoder.

10. The computer-implemented method of claim 9, further comprising:
generating, based on the language embedding, a body geometry;
generating, based on the language embedding, a hair geometry;
performing one or more optimization steps, based on the body geometry, the hair geometry, the object geometry, and the natural language input, to generate an optimized character appearance; and
generating, based on the optimized character appearance, a virtual character.

11. One or more non-transitory computer-readable media storing instructions that, when executed by one or more processors, cause the one or more processors to perform the steps of:
performing, based on object data, one or more operations to train an untrained machine learning model to generate a trained machine learning model that comprises a trained encoder and a trained decoder, wherein the trained machine learning model is trained to generate an object surface representation; and
performing, based on the object data and natural language data, one or more operations to train an untrained diffusion model to generate a trained diffusion model, wherein the trained diffusion model is trained to generate an object geometry embedding,
wherein the trained diffusion model and the trained decoder are used to generate a virtual object based on natural language input.

12. The one or more non-transitory computer-readable media of claim 11, wherein performing the one or more operations to train the untrained machine learning model to generate the trained machine learning model comprises:
generating, based on the object data, an object geometry and a first object surface representation;
generating, based on the object geometry, a first object geometry embedding using an untrained encoder;
generating, based on the first object geometry embedding, a reconstruction of the first object surface representation using an untrained decoder;
calculating, based on the first object geometry embedding, the reconstruction of the first object surface representation, and the first object surface representation, a loss; and
updating, based on the loss, one or more parameters of the untrained encoder and the untrained decoder.

13. The one or more non-transitory computer-readable media of claim 11, wherein performing the one or more operations to generate the trained diffusion model comprises:
generating, based on the natural language data, a language embedding;
generating, based on the object data, an object geometry;
generating, based on the object geometry, a first object geometry embedding using the trained encoder;
adding noise to the first object geometry embedding to generate a noisy object geometry embedding;
performing one or more denoising steps, using an untrained diffusion model, to generate a predicted object geometry embedding based on the noisy object geometry embedding;
calculating, based on the first object geometry embedding and the predicted object geometry embedding, a loss; and
updating, based on the loss, one or more parameters of the untrained diffusion model.

14. The one or more non-transitory computer-readable media of claim 11, wherein performing the one or more operations to train the untrained diffusion model to generate the trained diffusion model comprises performing one or more layer-wise training operations to disentangle one or more objects from one or more other components.

15. The one or more non-transitory computer-readable media of claim 14, wherein performing the one or more layer-wise training operations comprises generating one or more object-only prompts that avoid entangling an object geometry with one or more non-object geometries.

16. The one or more non-transitory computer-readable media of claim 11, where the trained diffusion model comprises an elucidated diffusion model.

17. The one or more non-transitory computer-readable media of claim 11, wherein generating the virtual object comprises:
generating, based on the natural language input, a language embedding; and
generating, based on the language embedding, an object geometry using the trained diffusion model and the trained decoder.

18. The computer-implemented method of claim 17, wherein generating the object geometry comprises:
generating, based on the language embedding, a predicted object geometry embedding using the trained diffusion model;
generating, based on the predicted object geometry embedding, a first object surface representation; and
generating, based on the first object surface representation, the object geometry.

19. The one or more non-transitory computer-readable media of claim 17, wherein the instructions, when executed by the one or more processors, further cause the one or more processors to perform the steps of:
generating, based on the language embedding, a body geometry;
generating, based on the language embedding, a hair geometry;
performing one or more optimization steps, based on the body geometry, the hair geometry, the object geometry, and the natural language input, to generate an optimized character appearance; and
generating, based on the optimized character appearance, a virtual character.

20. A system comprising:
one or more memories storing instructions, and
one or more processors that are coupled to the one or more memories and, when executing the instructions, are configured to:
perform, based on object data, one or more operations to train an untrained machine learning model to generate a trained machine learning model that comprises a trained encoder and a trained decoder, wherein the trained machine learning model is trained to generate an object surface representation, and
perform, based on the object data and natural language data, one or more operations to train an untrained diffusion model to generate a trained diffusion model, wherein the trained diffusion model is trained to generate an object geometry embedding,
wherein the trained diffusion model and the trained decoder are used to generate a virtual object based on natural language input.
